(19) United States
(12) Patent Application Publication
(10) Pub. No.: US 2026/0228119 A1
(43) Pub. Date: Aug. 6, 2026

(54) System and Method for Data-Driven Testing Using Object-Oriented Test Data, Smart Widgets, and Supporting Spreadsheet-Based Data Management

(71) Applicant: Kim Filiatrault, Round Rock, TX (US)

(72) Inventor: Kim Filiatrault, Round Rock, TX (US)

(21) Appl. No.: 19/046,502

(22) Filed: Feb. 5, 2025

(51) Int. Cl. G06F 11/3698; G06F 11/3604

(52) U.S. Cl. CPC G06F 11/3698; G06F 11/3612

(57) ABSTRACT

A system and method for enhancing data-driven testing through object-oriented test data, smart widgets, and support for spreadsheet-based data management. Object-oriented test data improves organization, readability, reuse, and scalability while reducing redundancy and data bloat. Smart widgets introduce dynamic execution with conditional test flow processing, selectively bypassing or modifying interactions based on test data, eliminating complex manual scripting. Embedded analytics within smart widgets track test coverage and performance, providing execution insights without extra scripting. Furthermore, support for object-oriented data goes beyond traditional structured data technologies like databases, JSON, and XML to directly support spreadsheets, allowing business users, testers, and developers to collaborate using familiar tools without requiring specialized programming expertise. By combining object-oriented test data, smart widgets, and flexible data management, the invention delivers a scalable, maintainable, and resilient automated testing framework that adapts to evolving application changes with minimal maintenance effort.

### BACKGROUND OF THE INVENTION

Data-driven testing (DDT) is a cornerstone of effective test automation however, traditional data-driven testing frameworks typically treat each test as an isolated entity, with all the necessary test data encapsulated within a single instance of the test. While these entities may reside within a shared container, such as an Excel sheet, each row often encapsulates most, if not all, of the needed data for a single test, but this structure typically lacks mechanisms for data reuse or cross-test sharing. This approach results in limited data sharing between tests, leading to challenges such as data duplication, inefficient data management, and data bloat.

These limitations are further exacerbated by the manual effort required to create and maintain such test data. Test engineers often need to replicate similar data across multiple tests, making the process error-prone and time-consuming. Traditional frameworks also require extensive scripting to implement the logic necessary to manage test flows, as this logic is typically embedded directly within the test scripts themselves. By contrast, the described process uses smart widgets to dynamically incorporate this logic based on the test data, significantly simplifying test creation and reducing the scripting burden on test engineers. While the loading of object-oriented (OO) test data is more complex and sophisticated than that of traditional data-driven testing, the process is abstracted from the test code, and managing the data is significantly simplified.

The described process addresses these challenges by introducing a novel approach that leverages object-oriented principles for test data and utilizes smart widgets to automate interactions with interface elements. By enabling test data to dynamically manage test flows, the process significantly reduces the need for test engineers to embed complex logic within individual tests while enhancing data reuse and adaptability. The object-oriented test data structure allows for efficient reuse and sharing of data across tests, significantly reducing duplication and minimizing data bloat, even when using familiar tools such as Excel.

By integrating object-oriented test data with smart widgets and supporting familiar tools like Excel, the process empowers business teams to directly contribute to test scenarios without requiring technical expertise. Additionally, the combination of object-oriented test data and smart widgets simplifies test creation, improves maintainability, and provides a scalable and sustainable solution for test automation, removing barriers and reducing costs.

### SUMMARY OF THE INVENTION

The invention provides a scalable, maintainable, and resilient framework for automated testing by integrating object-oriented test data, spreadsheet-based test data management, and smart widgets. Object-oriented test data structures improve test organization and reuse, spreadsheet-based environments such as Excel enable broad collaboration between business and technical users, and smart widgets enhance test execution by abstracting User Interface (UI) interactions, enabling conditional logic, and capturing execution analytics. These innovations collectively improve test automation efficiency, adaptability, and long-term sustainability.

Traditional test automation frameworks rely on rigid, flat data structures that require excessive duplication, making maintenance complex and scalability difficult. This invention introduces an object-oriented approach to test data management, structuring test data into reusable, hierarchical entities rather than isolated records. This improves readability, eliminates redundancy, and allows modifications to propagate automatically across test cases. While spreadsheets provide a widely accessible implementation for business users, object-oriented test data is not limited to spreadsheet-based management and can be implemented using various structured data storage technologies, such as relational databases, JSON, or XML, as demonstrated in FIGS. 30-33. By enabling spreadsheet-based test data management, this invention allows business users, testers, and developers to collaboratively define and maintain test data using familiar tools without requiring specialized database or programming expertise.

Smart widgets extend test automation capabilities beyond traditional Page Object Models by enabling dynamic test execution. These widgets determine the appropriate User Interface interactions based on test data, selectively bypass interactions for missing or disabled elements, and support conditional logic to modify test behavior without requiring updates to test scripts. Embedded analytics track execution metrics, providing insights into test performance and coverage while ensuring adaptability across evolving application interfaces.

By combining object-oriented test data, spreadsheet-based management, and smart widget technology, the invention significantly reduces test maintenance overhead, improves resilience to User Interface and application changes, and enables seamless collaboration between business and technical teams. This approach enhances the efficiency and sustainability of test automation while ensuring long-term adaptability in complex testing environments.

### BRIEF DESCRIPTION OF DRAWINGS

FIG. 1—Flowchart for data-driven testing development incorporating object-oriented test data.

FIG. 2—Example of traditional data-driven spreadsheet with test data flattened to a single test row.

FIG. 3—Logical groupings of fields that represent real-world objects to be grouped into object-oriented entities.

FIG. 4—Sample reference worksheet for object-oriented Person entities within an Account workbook.

FIG. 5—Sample reference worksheet for object-oriented Address entities within an Account workbook.

FIG. 6—Sample reference worksheets for object-oriented Vehicle and Coverage entities within a Personal Auto workbook.

FIG. 7—Sampe of one object-oriented reference worksheet for object-oriented Policy entities within a Shared workbook.

FIG. 8—Samples of two approaches to identifying Reference Worksheets locations for a test.

FIG. 9—Sample test worksheet with the use of reserved word, reference, override, and custom columns.

FIG. 10—Flowchart depicting the process for loading object-oriented test data from test and reference worksheets.

FIG. 11—Diagram showing the results of loading object-oriented test data from reference worksheets.

FIG. 12—Diagram showing the results of loading multiple references to same-type entities from reference worksheets.

FIG. 13—Diagram showing the results of test data overrides.

FIG. 14—Diagram showing the results of test-specific custom fields.

FIG. 15—Diagram showing the complete results of references, overrides, and custom fields being loaded.

FIG. 16—object-oriented data structure for test consumption after loading

FIG. 17—Traditional data structure for test consumption after loading

FIG. 18—Architecture diagram of the test data structure with loaded reference entities.

FIG. 19—traditional data structure demonstrating how test data is represented using flattened fields and accessors in a single class

FIG. 20—Sample code for a test using object-oriented test data.

FIG. 21—Sample code for a test using traditional flattened test data.

FIG. 22A—High-level architecture of smart widgets, illustrating their integration with test data, runtime engines, and analytics.

FIG. 22B—Workflow of smart widget interactions, showcasing data processing, conditional logic, User Interface interaction, verification, and logging.

FIG. 22C—Hierarchical representation of smart widget types and their abstraction layer for interaction with multiple runtime engines.

FIG. 22D—Analytics layer architecture, detailing data collection, logging, and reporting for test coverage and performance insights.

FIG. 23—Sample code to set data using Selenium and Playwright, two common User Interface automation tools.

FIG. 24—Flowchart depicting smart widget execution, including conditional processing, verification, and analytics tracking.

FIG. 25—Sample Person worksheet for following code description.

FIG. 26—Sample Vehicle worksheet for following code description.

FIG. 27—Sample Test worksheet using Person and Vehicle data.

FIG. 28—Sample code demonstrating object-oriented test data integration with smart widgets.

FIG. 29—Sample code demonstrating traditional test data supporting multiple entities.

FIG. 30—Account reference data in JSON format showing first two Person and Address entries from FIGS. 4 and 5.

FIG. 31—Account reference data in XML format showing first two Person and Address entries from FIGS. 4 and 5.

FIG. 32—Account Person reference data as database table showing first two entries from FIG. 4, including table creation, data loading, and retrieval.

FIG. 33—Account Address reference data as database table showing first two entries from FIG. 5, including table creation, data loading, and retrieval.

FIG. 34—High-level architecture diagram showing system-agnostic data loading, test execution, and widget processing components.

FIG. 35—Internal memory representation showing the Reference Repository hash map structure after loading reference data.

FIG. 36—Rule-based data loading process performed by the Framework Data Loader from storage-agnostic sources.

FIG. 37—Column classification and processing performed by the automation framework when transforming a test row into a fully-populated test entity.

FIG. 38—Override History structure showing recorded override operations including entity type, code, property, original value, new value, and source.

FIG. 39—Test data expansion through override combinations demonstrating test coverage growth from reference entities.

### DETAILED DESCRIPTION OF THE INVENTION

The invention provides a novel system for enhancing data-driven testing through the integration of object-oriented test data structures and the use of Page Object Models (POMs) incorporating smart widgets to add functionality and simplify the test writing process.

Traditional data-driven testing frameworks treat the data for each test as an isolated entity with all necessary data to complete the test. This requires significant manual effort to replicate and maintain similar test data, leading to inefficiencies such as data duplication, data bloat, and limited scalability. The described invention overcomes these limitations by introducing an architecture that enables dynamic, reusable test data and simplifies the test writing process through smart widgets.

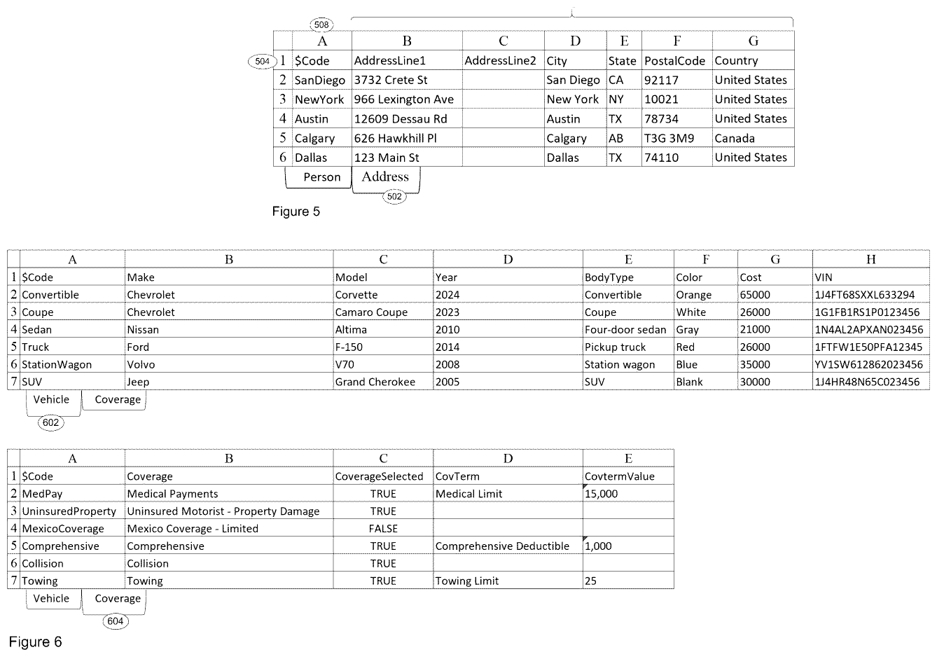

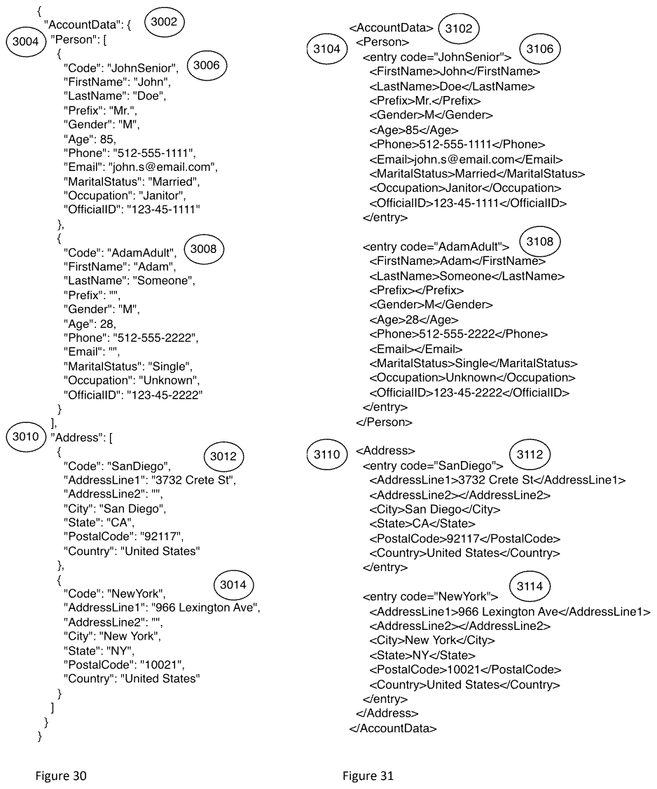

In this invention, object-oriented test data structures are designed to be independent of the underlying storage format and can be implemented using various data engines, including JSON, XML, databases, and spreadsheets. The independent claims reflect this flexibility by defining the invention in a manner that is not restricted to a specific data format. This detailed description primarily references an Excel-based implementation due to its extensive use in business environments and because it offers a familiar and collaborative mechanism for managing test data. While JSON, XML, and databases support hierarchical groupings of common entity types—as demonstrated in FIGS. 30-33 alongside the Excel implementation shown in FIGS. 4 and 5—none of these storage technologies inherently support the dynamic entity loading, reference resolution, and override processing presented in this invention. The automation framework implements specialized processing to load data from any storage mechanism, producing identical object-oriented data structures regardless of source format. No storage-specific logic, formulas, or calculations are utilized—each format serves as passive storage containing only static values organized for retrieval by the framework. This ensures that object-oriented test data principles are maintained while allowing business users, testers, and developers to collaboratively manage test data within their preferred environment.

Traditional testing frameworks may incorporate Page Object Models with widgets that provide access to and basic interactions with page elements, such as finding elements, clicking them, setting their values, or retrieving information. Smart widgets extend this functionality to incorporate testing and flow logic, as well as saving analytic data directly within the widgets to remove it from the test code to again simplify test writing and maintenance.

The system comprises several key components, including object-oriented test data structures designed to maximize reuse and minimize duplication by abstracting test data into sharable entities rather than isolated instances. Smart widgets dynamically interact with application interface elements not just to identify, click, set or retrieve information, but incorporating logic based on the test data to manage test flows without requiring code directly in the test. Shared data containers, such as Excel, JSON, XML, databases, or other similar platforms, store and organize test data in a way that supports object-oriented principles while remaining accessible to business users. The automation framework integrates these components and orchestrates their interactions to execute automated tests.

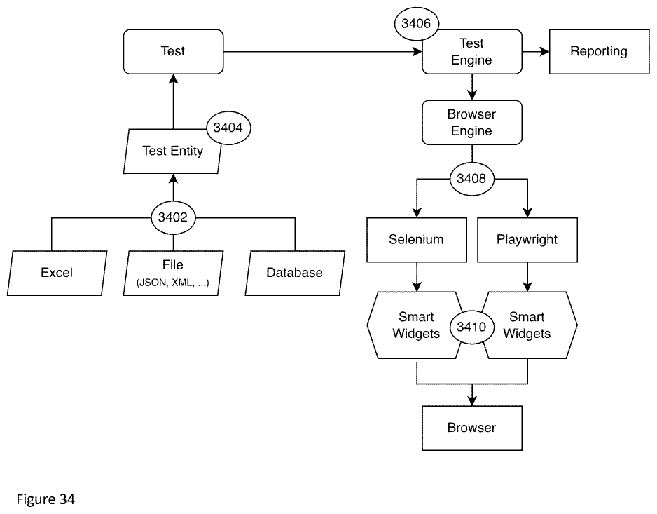

FIG. 34 illustrates the high-level system architecture demonstrating the storage-agnostic and engine-agnostic nature of the invention. Data loading (3402) provides storage-agnostic data loading from Excel workbooks, JSON/XML files, or database tables, producing identical object-oriented data structures regardless of source format. During data loading, the Test Entity (3404) is constructed by retrieving reference entities, applying test data overrides, managing multi-instance references, and processing keywords. The resulting Test Entity is provided to the Test, which sends it along with the test instructions to the Test Engine (3406). The Test Engine supports flow control and implementation of multi-instance references during test execution. The Test Engine determines which Browser Engine to use (3408) based on property settings, and the invention's Smart Widgets (3410) are implemented specific to each browser engine, abstracting engine-specific interactions while providing consistent test execution regardless of the underlying automation technology.

In the object-oriented data-driven testing process, workflows and the required test data are first identified, similar to traditional approaches. Rather than storing data as isolated rows in a generic container, the data is organized into reference entities based on object-oriented principles. Examples of reference entities include Person, which contains fields such as name, birthdate, and contact information; Company, which contains fields such as company name, registration number, and address; and Address, which contains fields such as street, city, state, and zip code.

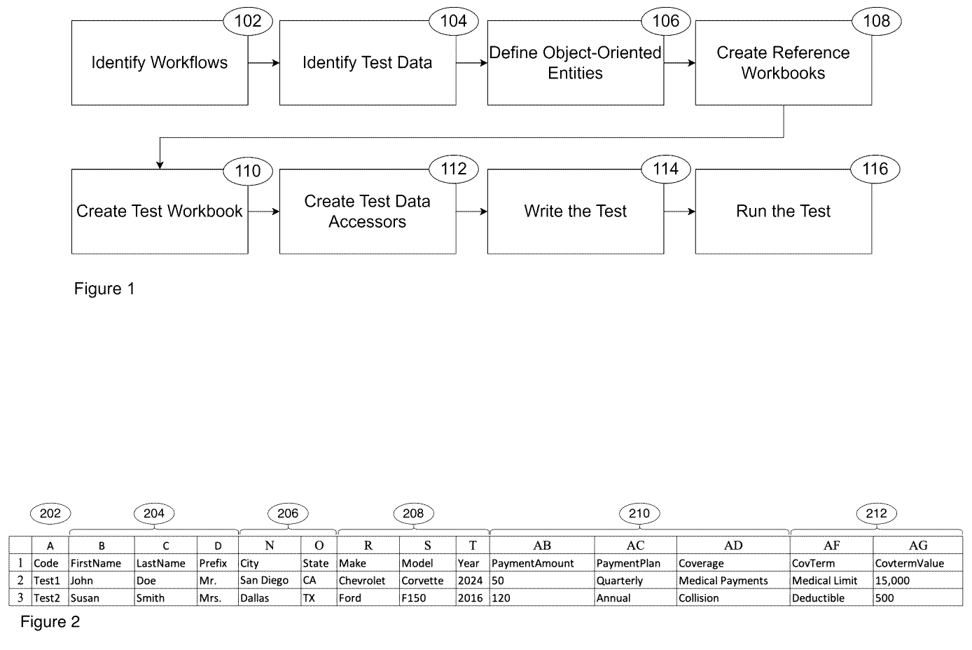

Referring to FIG. 1, the fundamental process for data-driven testing consists of several key steps, which ensure the seamless execution of tests using structured data. These steps begin with identifying workflows (102), where the functional and data-driven requirements for the test are defined. Next, the test data needed to support these workflows is identified and collected (104). These steps form the foundation for understanding the flow of the application and the data it requires for execution.

Once workflows and test data are identified, the test workbook is created (110). This workbook consolidates the required test data into a structured format suitable for the testing framework. Afterward, data accessors are created, either manually or generated (112) to simplify access to the data during test creation. This process involves reading the test workbook's structure, identifying data fields, and creating programmatic methods to interact with the test data during execution. This step will be in further detail later.

After the data accessors are created, the test itself is written (114), leveraging the data accessors and the structured data. Finally, the test is executed 116, utilizing the data-driven structure to verify application workflows dynamically. These steps—identifying workflows, collecting test data, creating the test workbook, generating accessors, writing the test, and running the test—constitute the basic process shared by traditional data-driven testing frameworks.

For object-oriented data-driven testing, the core process is extended with two additional steps that introduce a hierarchical and modular structure to the test data. The first additional step is defining object-oriented entities (106). This involves categorizing the identified data into reusable entities, such as Person, Company, or Address, which encapsulate related fields into discrete units. These entities form the building blocks of the object-oriented data-driven testing structure, allowing for data reuse and logical separation. More to come.

The second additional step is creating reference workbooks (108). Reference workbooks serve as containers for the entity-specific data, grouping related reference worksheets into a modular structure. These workbooks enhance scalability and maintainability by allowing common shared data to be used across your testing needs. Together, these additional steps enable object-oriented data-driven testing to provide a flexible, hierarchical data structure that integrates seamlessly with smart widgets and other advanced testing features.

While the fundamental steps of data-driven testing—such as creating the test workbook or generating accessors—may differ slightly in implementation to support the object-oriented structure, their underlying principles remain consistent. The addition of object-oriented entities and reference workbooks complements the traditional process, enabling a more robust and scalable testing framework.

In transitioning from traditional data-driven testing to object-oriented data-driven testing, one of the key steps is defining object-oriented entities based on the traditional flat data structure. Traditional test spreadsheets, like the one shown in FIG. 2, will contain numerous columns, one for the unique Code or Identifier (202) for each test row and the others representing each property or field necessary for testing. These columns are a flattened representation of the test data and can quickly become unwieldy as the number of fields grows. FIG. 2 demonstrates an example of this with a Code (202) column and test fields for Person (204), Address (206), Vehicle (208), Policy (210), and Coverage (212) spread across a single spreadsheet, though for the sake of readability, several columns are hidden, including E-M, P-Q, U-AA, and AE. This is a relatively simple example.

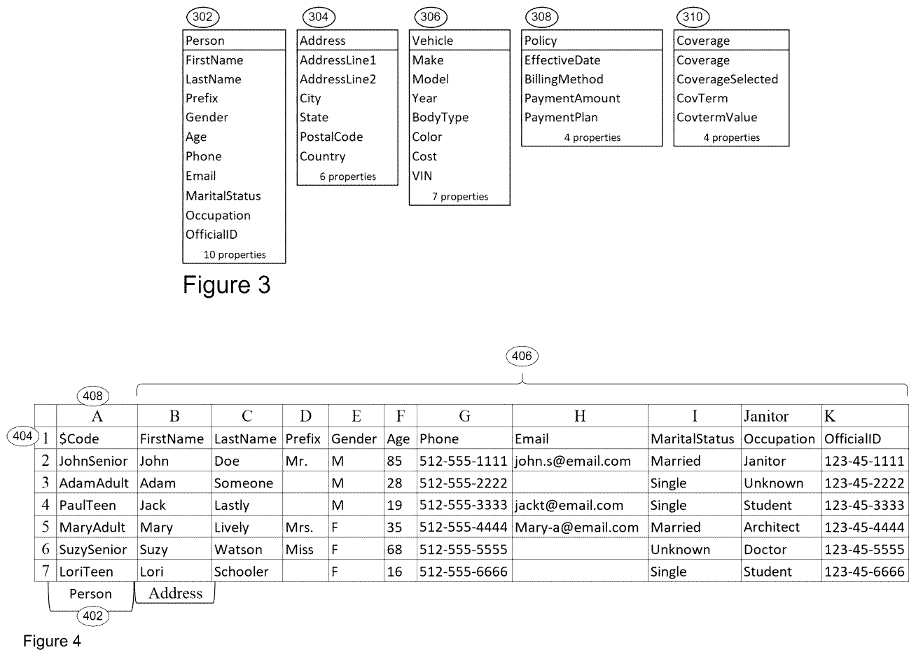

To create a more meaningful and scalable structure, we will employ object-oriented principles and organize these fields into real-world entities that reflect the relationships between the data. This process involves identifying logical groupings of fields that represent distinct concepts or objects, as shown in FIG. 3 with Person (302), Address (304), Vehicle (306), Policy (308), and Coverage (310) entities. Each entity encapsulates related fields into a discrete, reusable structure. For instance, the Person (302) entity groups related fields like FirstName, LastName, and Prefix from the flat structure (204) into a cohesive reference entity, while the Address (304) entity consolidates fields such as City and State (206) into its own reference entity.

By mapping these fields into entities, the test data becomes more modular and intuitive. Each entity corresponds to a reference worksheet in the object-oriented data-driven testing framework, with all properties associated with that entity stored in a structured manner. This approach not only enhances data reuse but also simplifies test maintenance by logically separating the fields into manageable units. The ability to group and organize data in this manner represents a fundamental shift in how test data is conceptualized and managed.

The creation of reference worksheets is a critical step in transitioning from a traditional flat test data structure to an object-oriented data-driven testing framework. This process involves organizing related entities into structured reference worksheets and grouping them into reference workbooks based on logical relationships. Each reference worksheet is dedicated to a specific entity, with rows representing individual instances of that entity and columns corresponding to its properties. Each Reference worksheet contains a header row listing field or property names associated with the entity and one or more test rows that contain the data needed for testing purposes.

In the Account Reference Workbook FIG. 4 and FIG. 5, the Person worksheet (402) includes a header row (404) which identifies the fields from the Person (302) entity such as FirstName, LastName, Age, and Email (406), while the Address worksheet (502) contains the corresponding fields from the Address (304) entity such as AddressLine1, City, and State (504). This modular approach ensures that data is logically grouped and easy to manage, making it reusable across multiple tests.

To uniquely identify each data row, every reference worksheet includes a special identifier column, such as Code or ID (408, 506). These identifiers are used in reference worksheets to dynamically retrieve specific data rows during test execution. For example, when executing a test, the system can reference the Account workbook to load a Person (402) and their associated Address (404) by using a specific code such as Austin (508) in the test worksheet.

You may notice the use of a “$” preceding the Code (408) column name, this will be explained with the Test worksheet.

A Reference workbook must contain one or more Reference worksheets as desired, but grouping related entities into a single workbook further enhances the scalability and modularity of this invention.

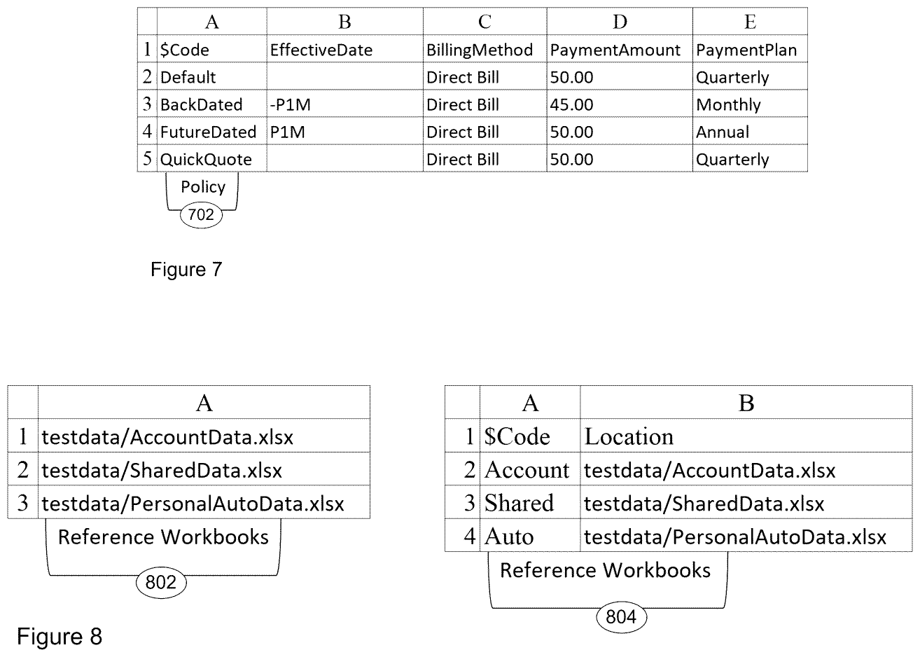

Three remaining worksheets are shown to further explain this invention. These include the Personal Auto reference workbook in FIG. 6 which contains the Vehicle (602) worksheet and the Coverage (604) worksheet. The Shared reference workbook shown in FIG. 7 contains the single Policy (702) worksheet. FIGS. 6 and 7 show the use of Reference workbooks containing either one or more than one reference worksheets.

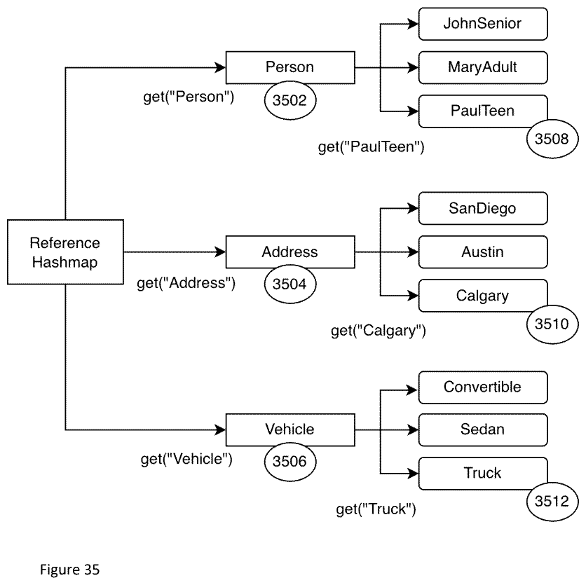

While FIGS. 4 through 7 illustrate reference data organized in spreadsheet format, the invention is fundamentally storage-agnostic. The framework processes reference data identically regardless of whether that data originates from spreadsheets, JSON files, XML documents, or relational databases. FIGS. 30 through 33 demonstrate this flexibility by presenting the same Account reference data—the first two entries from the Person and Address entities introduced in FIGS. 4 and 5—in alternative storage formats. Regardless of source format, all data loads into the identical internal memory structure shown in FIG. 35.

This storage-agnostic design is critical: storage containers serve purely as data vessels—they contain no formulas, perform no calculations, and execute no processing logic. All semantic processing occurs within the automation framework.

FIG. 30 illustrates reference data in JSON format. The AccountData object (3002) serves as the root container, with Person (3004) and Address (3010) arrays grouping entities by type. Each entity includes a Code property as the unique identifier (3006, 3008, 3012, 3014) along with the same properties defined in the spreadsheet-based reference worksheets.

FIG. 31 illustrates the same data in XML format. The AccountData element (3102) contains Person (3104) and Address (3110) elements, with individual entities represented as entry elements using a code attribute for identification (3106, 3108, 3112, 3114).

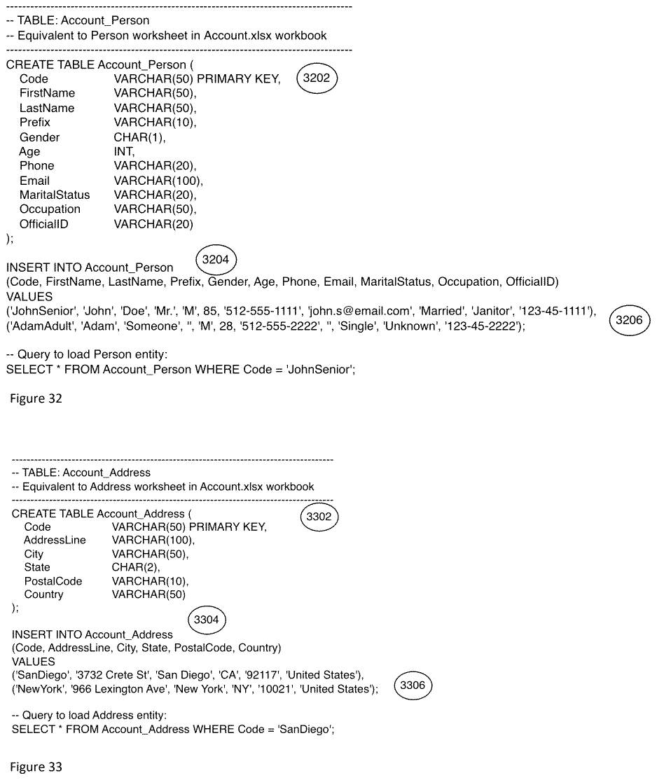

FIGS. 32 and 33 illustrate database representations for Person and Address entities respectively. Each figure shows a table schema (3202, 3302), insert statements (3204, 3304) that populate the reference data (3206, 3306), and a select query demonstrating entity retrieval by code.

Comparing FIGS. 30-33 to FIGS. 4-5 demonstrates that while syntactic representation differs across formats, the logical structure remains identical: a container groups entities by type, each entity has a unique code identifier, and each entity contains the same properties. The framework abstracts these syntactic differences during loading.

FIG. 34 illustrates the complete system architecture. On the left, three storage source types (3402)—Excel, File (JSON, XML), and Database—converge to produce a unified Test Entity (3404). The Test Entity presents an identical interface to test code regardless of the underlying data source.

On the right, the test execution flow shows the Test interfacing with the Test Engine (3406) for execution management and reporting. The Browser Engine (3408) abstracts the choice between runtime engines such as Selenium and Playwright. Smart Widgets (3410) manage User Interface interactions before reaching the Browser.

This architecture demonstrates clear separation: the data layer (3402, 3404) handles storage-agnostic loading; the execution layer (3406-3410) handles test orchestration. Storage technology choice has no impact on test execution.

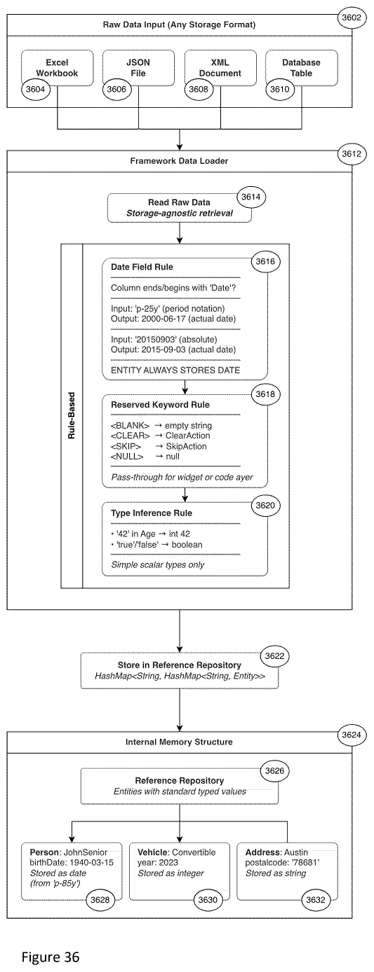

FIG. 35 illustrates the internal memory structure after reference data loading. The Reference Repository uses a hash map of hash maps structure providing O(1) lookup performance. The outer hash map is keyed by entity type such as Person (3502), Address (3504), and Vehicle (3506); each inner hash map is keyed by entity code such as PaulTeen (3508), Calgary (3510), and Truck (3512). This dual-lookup pattern—get(“Person”). get(“PaulTeen”)—retrieves the complete entity object regardless of the original storage format. This structure is identical regardless of source format. Whether data was loaded from Excel, JSON (FIG. 30), XML (FIG. 31), or database (FIGS. 32-33), the resulting hash map structure is indistinguishable. The framework's loading process, illustrated in FIG. 36, transforms all source formats into this unified representation.

FIG. 36 illustrates the rule-based data loading process. Raw data input (3602) from any storage format—Excel workbook (3604), JSON file (3606), XML document (3608), or database table (3610)—is processed by the Framework Data Loader (3612) through storage-agnostic retrieval (3614). During loading, the framework applies rule-based transformations to convert raw string values into appropriate typed values.

The Date Field Rule (3616) identifies date columns by naming convention (columns beginning or ending with “Date”) and transforms period notation (such as ‘p-25y’) or absolute notation (such as ‘20150903’) into standard date objects. The Reserved Keyword Rule (3618) transforms special keywords—<BLANK>, <CLEAR>, <SKIP>, <NULL>—into framework-specific values for widget or code layer processing. The Type Inference Rule (3620) converts string values to appropriate scalar types based on content, such as ‘42’ to integer or ‘true’ to boolean.

After transformation, entities are stored (3622) in the Reference Repository (3626) within the Internal Memory Structure (3624), producing typed entity objects as shown in the examples (3628, 3630, 3632). This structure matches FIG. 35.

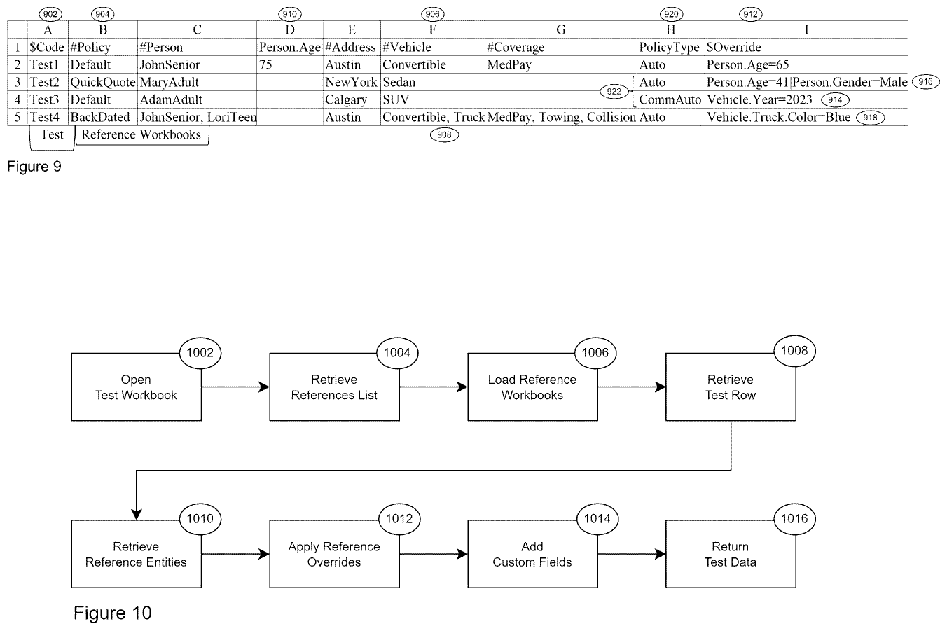

The Test workbook is a central component of the object-oriented data-driven testing process. It is used to manage and execute specific test scenarios by dynamically referencing data stored in Reference worksheets. Each Test Workbook contains two key worksheets: a Reference Workbooks worksheet shown in FIG. 8, which identifies the Reference workbooks that contain the Reference worksheets needed for the test; and the Test worksheet shown in FIG. 9, which contains all the data necessary to execute a specific test scenario.

The Reference Workbooks worksheet serves as a lookup table, listing the Reference workbooks (802) containing the necessary Reference worksheets for a test scenario. Each row specifies the path and name of a Reference Workbook, ensuring access to the required data while avoiding duplication

Unlike other Reference worksheets, the Reference Workbooks worksheet does not require a unique identifier for the entries nor even a header row; its purpose is to list the workbooks needed for the test. It can include a header row and a Code or Identifier column (804) for consistent style to the other worksheets, but this is not required.

The Test worksheet shown in FIG. 9 is the core of the Test workbook, identifying all the data necessary to execute a specific test. The first thing to note is the header row, which is very different from the header row of a Reference worksheet. Rather than having just a Code, Identifier columns and simple test data, the Test worksheet has four different types of columns: reserved-word columns, reference columns, override columns, and custom columns.

Reserved-word columns are columns needed for specific purposes by the invention. To distinguish reserved-word columns from non-reserved-word columns, the column name is prefixed with a special character, such as the “$” symbol. Reserved-word columns, such as $Code (902) and $Override (912) are used for specific system-level purposes. For example, $Code uniquely identifies each test case, allowing the system to dynamically reference and execute the associated test data. The uniqueness of these values is assumed, as their specific processing is handled within the testing framework.

Reference columns are distinguished from non-reference columns by using another special character such the “#” prefix, which clearly identifies them as linked to Reference worksheets. To dynamically link to a specific Reference worksheet, the name of the worksheet is prefixed with the “#” symbol, forming the reference column name. For example, the #Policy (904) column and the #Vehicle (906) columns are reference columns that link to the Policy worksheet and the Vehicle worksheets respectively. Columns C and G are also reference columns. This naming convention provides a consistent and scalable mechanism for associating test data with the appropriate reference entities, ensuring clarity and adaptability as additional Reference worksheets are introduced into the framework.

The value in the reference column serves as the key to identify the specific row in the corresponding reference worksheet. In addition, reference columns can support multiple entities by allowing a delimited list of keys. For example, the #Policy column includes Default for Test1 which loads the data for row Default in the Policy reference worksheet. Similarly, the #Vehicle column includes two values—Convertible, Truck (908)—for Test4 to retrieve data for both a Convertible and a Truck from the Vehicle reference worksheet.

Override columns are distinguished from non-override columns by their use of a dot-notation style, rather than a special prefix. This notation combines the reference worksheet name and the specific field to override, clearly identifying the target data. For example, in FIG. 9, Person. Age (910) refers to the Person reference worksheet, with Age specifying the column within that worksheet to be overridden.

Overrides allow testers to use a shared reference row while modifying specific values to meet unique testing requirements. This eliminates the need to duplicate reference rows for minor variations, reducing redundancy and improving data management. By enabling test-specific customizations, overrides enhance the flexibility and scalability of the testing framework, ensuring that tests can dynamically adapt to diverse scenarios.

Another consideration for overrides is the use of a reserved word, such as $Override (912), to consolidate multiple overrides into a single column with a special value format. For example, a value such as Vehicle. Year=2023 (914) in the $Override column functions similarly to the Person. Age override column but for a vehicle's year which does not have an explicit override defined. To accommodate multiple overrides within the same cell, a unique delimiter, such as the “|” character, can be used to separate the individual overrides, similar to a CSV structure. For instance, the value Person. Age=41|Person. Gender=Male (916) would override both the Age and Gender fields of the Person entity in a single column. To override fields for multi-object references, the code can be included in the identifier as seen in Vehicle. Truck. Color=Blue (918) which overrides the “Truck” entity.

Override column consolidates overrides, reducing the number of columns needed for more complex scenarios. Depending on the use case, either method can be utilized, balancing clarity and conciseness to avoid becoming overly cumbersome.

Custom fields (920) provide a mechanism to define test-specific data that is not tied to any reference worksheet. They are designed to offer maximum flexibility in test design, providing data unique to the test case and are therefore managed directly by the tester. Custom fields are represented as standard column names within the test worksheet, without requiring a special prefix or naming convention. For example, in this scenario, the Policy Type custom field may influence test flow as it differentiates between Auto and CommAuto (922) policy types.

These fields are particularly useful for edge cases or unique test conditions where predefined reference entities do not provide the required specificity. These fields are directly consumed by the test script and do not require additional preprocessing and allow testers to avoid modifying shared reference data, preserving its integrity while still tailoring test scenarios to specific needs.

The inclusion of custom fields enhances the adaptability of the testing framework by enabling data-driven tests to incorporate both standardized and unique data elements. This ensures that the framework supports a wide variety of test scenarios without compromising modularity or maintainability.

With the structure of the test worksheet defined-incorporating reference columns, reserved-word columns, override columns, and custom fields-the next step is the process of loading the test data. This process transforms the static data in the test worksheet and reference workbooks into a hierarchical, object-oriented data structure ready for use by the testing framework. Each type of column plays a distinct role in this process, from linking to reference entities and applying overrides to providing unique test-specific data. The details of this process, including handling multiple entities, applying overrides, and incorporating custom fields, will be explained in the following section, with accompanying diagrams illustrating each step.

Referring to FIG. 10, when loading object-oriented data for data-driven testing, the process begins by opening the Test workbook (1002). The test workbook serves as the central point for organizing and managing the test-specific data, as well as referencing external data sources. This initial step ensures the system can access both the test worksheet and the references list, which are required for subsequent steps.

Once the Test workbook is loaded, the references list from the Reference Workbooks worksheet is loaded (1004). This list identifies the external reference workbooks containing the data needed for the test. Each entry in the references list specifies the path and name of the corresponding workbook, allowing the system to locate and prepare the necessary external data sources.

Once the references list is available, the system opens each referenced workbook (1006). These reference workbooks contain entity-specific data organized into reference worksheets, which are critical for assembling the hierarchical test data structure. By accessing these workbooks, the system ensures all referenced entities, and their properties, are available for processing. The process is described in more detail in following diagrams.

After opening the referenced workbooks, the test worksheet is processed (1008). This worksheet includes the test case's specific data, such as reference fields (1010), override fields (1012), custom fields (1014), and the test identifier ($Code). The test worksheet acts as a blueprint for defining which entities and properties are required for the test and how they should be customized or combined. Finally, the merged test data is returned to the test as an object-oriented test object (1016).

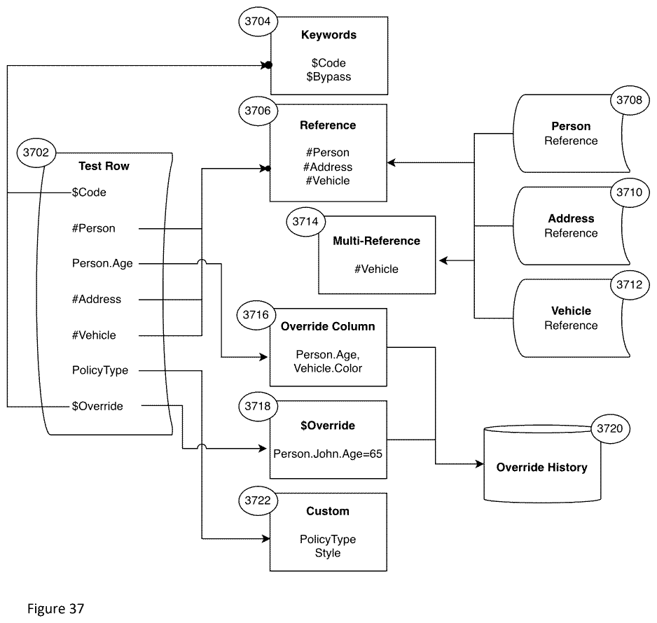

The following paragraphs describe the internal processing performed by the automation framework during test row retrieval (1008) through custom field addition (1014). FIG. 37 illustrates the column classification and routing performed when transforming a test row (3702) into a fully populated test entity. This processing occurs entirely within the framework and is independent of the underlying storage format.

Each column in the test row (3702) is classified based on naming conventions interpreted by the framework. Columns prefixed with “$” are identified as reserved keywords (3704) and control framework behavior, such as $Code for test identification and $Override for specialized override processing. Columns prefixed with “#” are identified as reference columns (3706) and trigger entity retrieval from the corresponding reference repositories—Person Reference (3708), Address Reference (3710), and Vehicle Reference (3712). When a reference column contains multiple comma-separated codes, the framework processes these as multi-instance references (3714), enabling a single test to operate with multiple entities of the same type.

Columns using dot-notation are classified as override columns (3716), where the notation identifies both the entity type and the property to override (e.g., Person. Age, Vehicle. Color). The reserved $Override column contains override custom specifications (3718) using extended notation that targets specific entity instances within the type and property. All override operations are logged to the Override History (3720) for audit and debugging purposes. Remaining columns that do not match reserved, reference, or override patterns are classified as custom fields (3722) and are loaded directly into the test entity.

The Override History is stored as an ordered list, preserving the sequence in which overrides were applied. This sequencing enables programmatic reconstruction of test entity state at each processing layer, supporting analysis, debugging, and audit requirements.

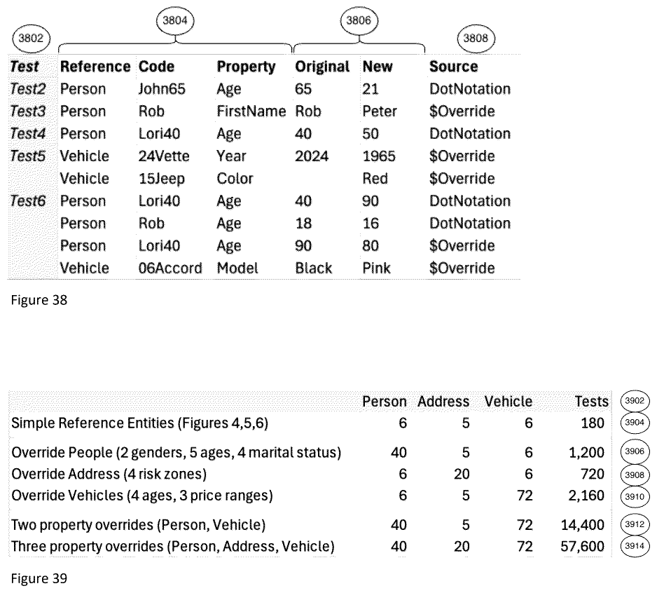

FIG. 38 illustrates the Override History structure. Each test maintains its own history independently; the Test column (3802) is shown for example purposes only. The key information (3804) includes the Reference entity type, entity Code, and Property being overridden. The before and after values (3806) capture the Original reference value and the New override value. The Source column (3808) identifies the override mechanism—DotNotation for Override Column (3716) or $Override for the reserved keyword (3718).

The examples in FIG. 38 demonstrate various override scenarios. Test2 and Test3 show simple single-entity overrides using Override Column (DotNotation) and $Override respectively. Test4 shows an override targeting the second entity in a multi-instance reference. Test5 demonstrates overriding both entities in a multi-instance cell with different properties for each—Vehicle 24Vette's Year and Vehicle 15Jeep's Color. Test6 illustrates override sequencing: Person Lori40's Age is overridden first by DotNotation (40 to 90), then by $Override (90 to 80), with both operations preserved in order. This history enables tracing exactly how each test entity value was derived.

The combination of classification-based reference entities and override processing enables significant test data expansion from minimal reference data. FIG. 39 illustrates this expansion using the reference entities shown in FIGS. 4, 5, and 6—six Person, five Address, and six Vehicle references totaling seventeen rows. The column headers (3902) identify each entity type and resulting test count. Simple reference combinations (6*5*6) produce 180 unique tests (3904).

Overriding Person properties transforms six base references into forty effective variations by combining two genders (male, female), five age classifications (child, teen, adult, senior, centenarian), and four marital statuses (single, married, divorced, unknown) expanding test combinations from 180 to 1,200 (3906). Overriding Address properties for four risk zone exposure (none, hurricane, earthquake, flood) transforms five references into twenty variations—expanding to 720 tests (3908). Overriding Vehicle properties by four age categories (new, used, classic, antique) and three price ranges (exotic, luxury, standard) transforms six references into seventy-two variations—expanding to 2,160 tests (3910). These overrides use the same base reference entities; no additional reference rows are created.

Combining Person and Vehicle overrides produces 14,400 unique test combinations (3912). Adding Address overrides increases the total to 57,600 tests (3914). While no test suite would execute all possible combinations, this demonstrates how quickly coverage can expand without creating new reference entities, all while keeping test data manageable. All expansion occurs entirely within the automation framework from the original seventeen reference rows, requiring no data duplication and no spreadsheet calculations.

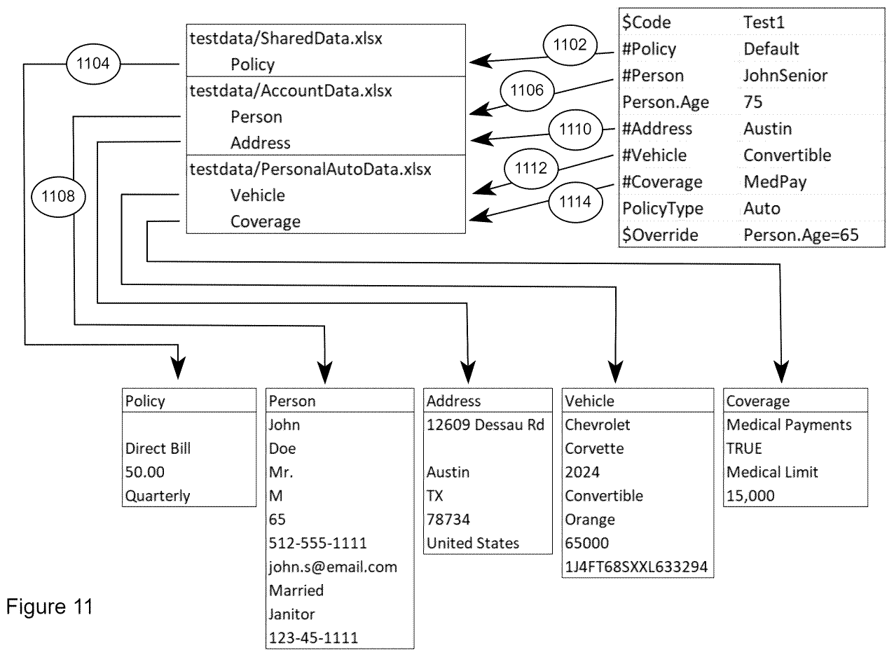

Processing the worksheet begins by loading the raw data from the row directly into a test object as depicted in FIG. 11. The diagram shows a test row flipped to show the data in a columnar fashion rather than a row to simplify the diagram and process explanation.

The system begins by identifying the reference columns in the test worksheet, which are distinguished by the leading # in their column names. Each reference column is processed sequentially, following their order in the worksheet. For each reference column, the system removes the leading # to determine the name of the associated reference worksheet and locates this worksheet within the open workbooks.

For example, the #Policy column in the test worksheet contains the value Default. The system uses this value to locate and load the corresponding row labeled Default (1102) from the Policy reference worksheet (1104). This row is then added to the test data as part of the hierarchical structure. Similarly, the #Person column (1106) has the value JohnSenior, which loads the data from the Person worksheet (1108). The process continues for the remaining reference columns, dynamically retrieving and loading Austin from the Address worksheet (1110), Convertible from the Vehicle worksheet (1112), and MedPay from the Coverage worksheet (1114).

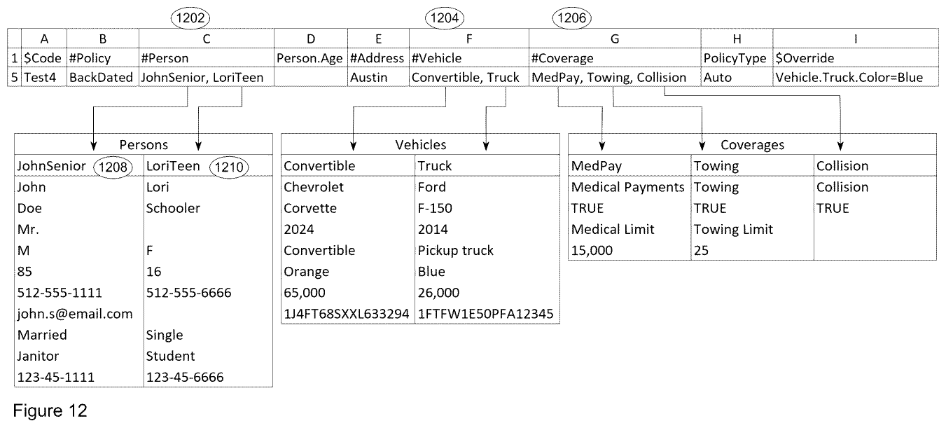

FIG. 12 shows three reference columns, #Person (1202), #Vehicle (1204), and #Coverage (1206), each containing multiple identifiers. Focusing on the #Person column, the system splits the delimited value in the test worksheet cell (JohnSenior, LoriTeen) and retrieves the corresponding rows from the Person reference worksheet. The loaded data is then organized into a list (1208), where each entry maintains its position, and the associated entity data is stored as sequential elements within the list (1210), including the reference code. #Vehicle and #Coverage follow the same pattern.

The system uses an iterator to process the split values sequentially, retrieving all the information for one entity at a time and storing it in a list. For instance, the iterator first accesses JohnSenior, retrieving data such as age (85), marital status (Married), and occupation (Janitor). It then moves to LoriTeen, retrieving her age (16), marital status (Single), and occupation (Student). This dynamic iteration ensures that all entities are fully loaded and linked to the test data structure without requiring hardcoded references in the test script. The same process is applied to other reference columns with multiple identifiers, such as #Vehicle and #Coverage, enabling scalable and flexible data handling for complex test scenarios.

When considering multiple entities of the same type in traditional data-driven testing, the entire entity would need to be repeated within the data container, but with uniquely named fields. For example, if a test required multiple persons, FirstName might be duplicated as FirstName2, FirstName3, and so on for each additional entity. This approach not only increases the complexity of the data structure but also makes the test script significantly more cumbersome to write and maintain. Each additional entity requires the creation of new field names and corresponding logic to handle them in the test code, making traditional data-driven testing processing for multiple entities highly inefficient and error-prone.

This process of sequentially loading reference data creates the foundational hierarchical layers for the test data structure, ensuring all required entities are dynamically linked and ready for subsequent processing.

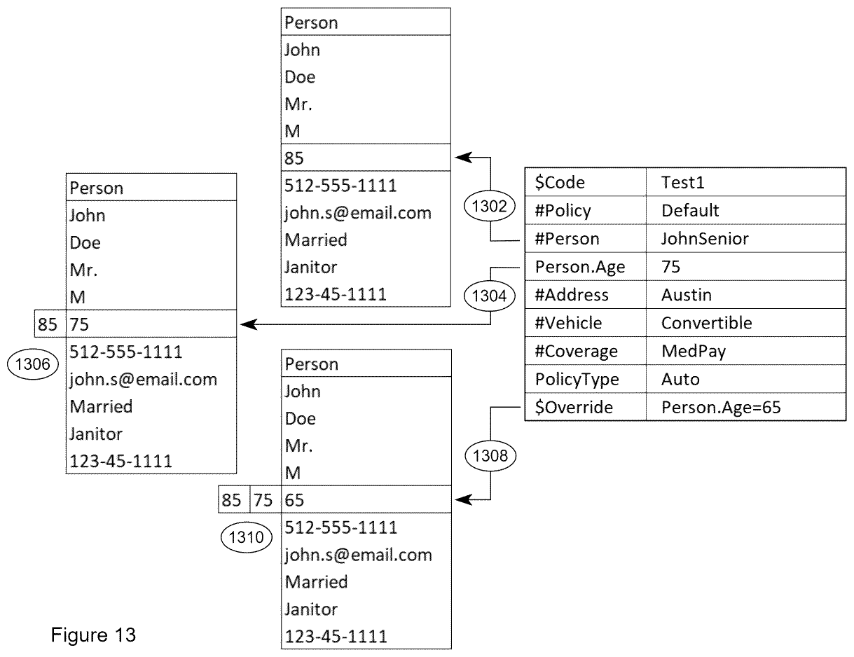

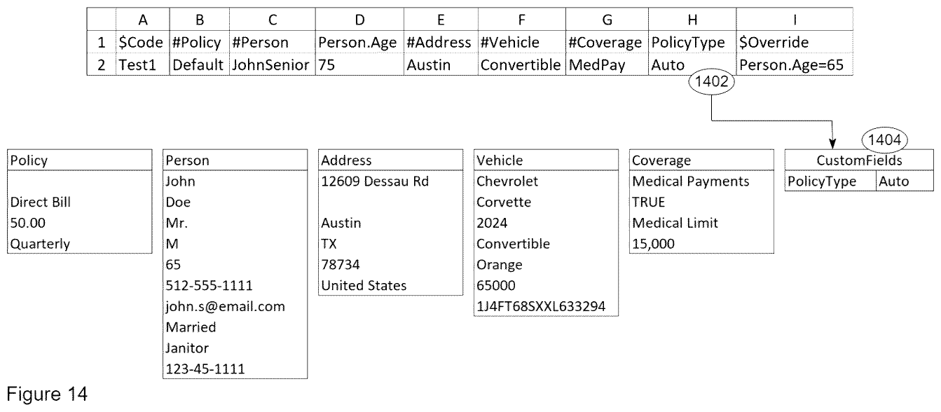

After all reference worksheets are loaded, overrides are processed by parsing their dot-notation format to identify the reference worksheet and the specific property being overridden. FIG. 13 illustrates the sequence and results of overrides, showing the original value for the age of John Doe as 85 (1302), loaded from the Person reference entity. The override column Person. Age is then parsed, and the person's age in the test data container is updated to 75 (1304), while the original value of 85 (1306) from the reference worksheet is retained. This dual retention of original and overridden values enables comprehensive test analysis, allowing users to compare modified data against its default state and better understand variations in test flows and results.

After override columns are processed, the reserved $Override column follows the same model, dynamically parsing its values to determine the reference worksheet and property to override. For instance, the $Override value Person. Age=65 (1308) updates the person's age property to 65. The system retains the original reference value of 85 (1310), and also the current value of 75 stored by the Person. Age column. Processing $Override values last ensures that they take precedence over other overrides, giving testers the flexibility to define final customizations. It would not be typical to override the same value by both methods, so an order of precedence must be clearly defined. By supporting both dedicated override columns and the reserved $Override column, the system provides flexibility in managing test-specific customizations while maintaining traceability of the original data.

The final step in the data loading process involves processing custom fields. Unlike reference entities or override values, custom fields are not tied to any specific reference worksheet or reserved system functionality. Instead, they provide test-specific data directly defined within the test worksheet. To ensure seamless integration, custom fields are loaded into a separate layer within the hierarchical data structure, commonly referred to as CustomFields. This layer is distinct from the reference entities and overrides but remains accessible in the same manner as those fields.

As shown in FIG. 13, the Policy Type column (1402) is identified as a custom field. During the loading process, the value Auto is read from the test worksheet and stored under the CustomFields layer (1404). This approach ensures that custom fields can be accessed programmatically using the same hierarchical structure used for reference and overridden fields. For example, the Policy Type value can be retrieved using a method such as data. getCustomFields( ). getPolicyType( ) in a Java-based implementation.

While custom fields most commonly provide data to populate test workflows, another valuable use case is providing result-related information. For instance, custom fields could be used to store expected results or metadata for a specific test scenario. This flexibility allows testers to define fields for validating outcomes or storing additional context for analysis, further enhancing the adaptability of the framework.

By organizing custom fields into their own layer, the system provides a consistent and modular way to handle additional test-specific data. This structure enhances test flexibility, allowing testers to include fields that fall outside predefined reference entities or system-reserved columns. Furthermore, the isolation of custom fields ensures that they do not interfere with reference or override data, maintaining the integrity of the hierarchical structure.

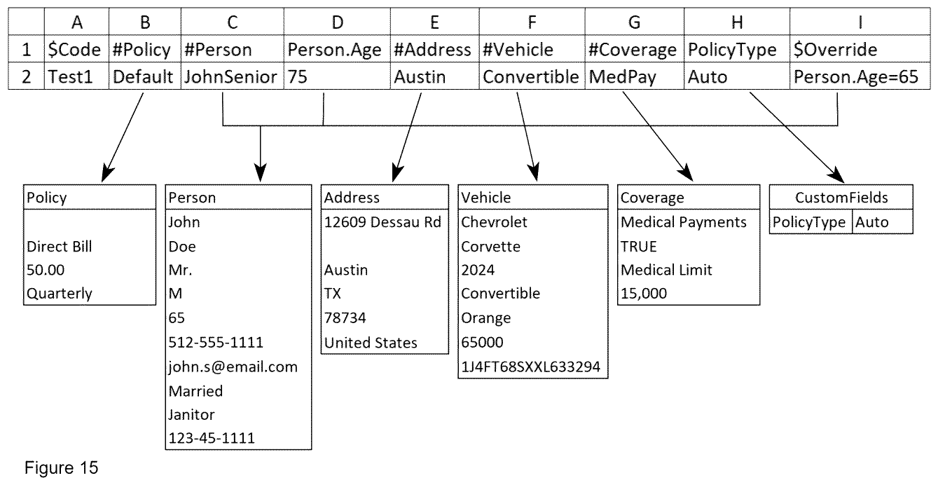

FIG. 15 provides a comprehensive overview of the completed loading process, including the sequential loading of all reference data, the application of overrides, and the incorporation of custom fields. Starting with the test worksheet, reference columns such as #Policy, #Person, #Address, #Vehicle, and #Coverage dynamically retrieve their associated rows from the respective reference worksheets. Overrides, such as Person. Age=65, modify specific properties while retaining the original reference values for analysis, ensuring traceability and flexibility. Custom fields, such as Policy Type, are added as a separate layer (CustomFields) to the hierarchical data structure, providing test-specific values that are independent of the reference or override data.

The result of this process is a fully populated, hierarchical test data object that combines all loaded reference entities, overridden values, and custom fields. Each element is dynamically linked and ready for access during test execution, enabling scalable and adaptable data-driven testing. This consolidated data structure forms the foundation for subsequent processes, such as generating accessors to simplify interactions with the test data.

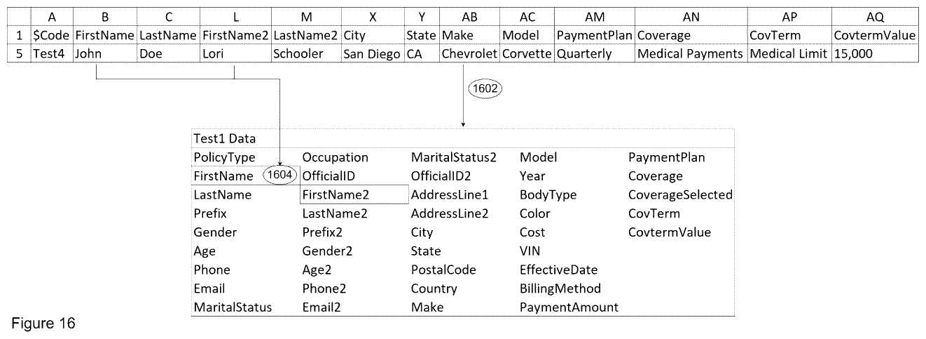

In traditional frameworks, generating accessors is straightforward, often supported by development tools such as IntelliJ, Eclipse, or similar Integrated Development Environments (IDEs). FIG. 16 shows how developers can quickly generate getter and setter methods by pasting field names into a class definition and using built-in generation tools. This simplicity is enabled by the flat structure of traditional data-driven frameworks, where all properties exist on a single hierarchical level within the test data object (1602). However, this structure introduces challenges when different entities share the same property name. For example, a Year field for a Person entity might refer to the year of birth, while a Year field for a Vehicle entity might refer to its year of production. Additionally, replicated entities, such as Person, require duplicative naming, as shown with fields like FirstName and FirstName2 (1604) for two separate instances of the same entity. This repetitive naming not only increases complexity but also makes the data structure harder to maintain and the test scripts prone to errors. FIG. 16 includes examples of such replicated fields to illustrate the inefficiencies of flat structures.

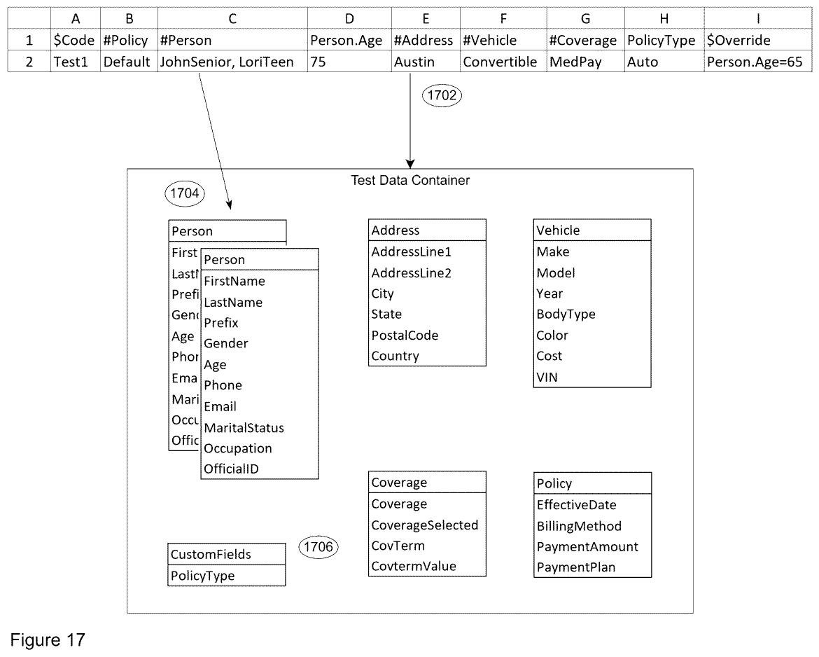

In object-oriented data-driven testing, generating accessors requires a more sophisticated approach to align with the hierarchical structure of the data as shown in FIG. 17 (1702). The process involves dynamically reading all reference worksheets and workbooks to identify the properties associated with each reference entity. For instance, the Person entity may include properties such as FirstName, LastName, Age, and Year, while the Vehicle entity may include properties such as Make, Model, Year, and Color. Unlike traditional flat structures, where shared property names like Year or replicated fields like FirstName2 can cause conflicts, the hierarchical structure in object-oriented test data inherently avoids such issues. Each Year property is self-contained within its respective class or layer (e.g., Person or Vehicle), maintaining clarity and avoiding ambiguity. Similarly, multiple Person entities can be managed using lists (1704). These lists allow efficient retrieval of individual entities and their properties, eliminating the need for duplicative naming while improving scalability.

Custom fields are similarly processed and added to a separate layer, commonly referred to as CustomFields (1706). This layer is distinct but follows the same accessor generation principles, enabling seamless access to both reference and custom data. For example, a custom field such as Policy Type would be accessible using a method like data. getCustomFields( ). getPolicyType( ) in a Java-based implementation. The separation of reference, override, and custom fields into distinct hierarchical layers ensures a structured and conflict-free approach to data access.

The hierarchical structure of object-oriented test data for data-driven testing not only resolves naming conflicts but also provides enhanced clarity and maintainability. Accessors are generated in such a way that each entity and its associated properties are encapsulated, making the data self-descriptive and reducing the need for additional conventions to avoid ambiguity. This design ensures the data structure is intuitive, scalable, and easier to navigate compared to traditional flat structures.

To further demonstrate the advantages of this approach, the following section examines the differences in code structure between traditional data-driven testing and object-oriented data-driven testing. FIGS. 16 and 17 illustrate these differences, providing examples of the resulting accessors derived from the previously described test data structures. These figures reference line numbers for clarity and highlight how hierarchical organization improves test code readability and maintainability.

For the purposes of this invention and for brevity, the code snippets are minimized to focus on the fundamental distinctions between traditional data processing and object-oriented data processing in data-driven testing. While simplified, these examples accurately represent real-world scenarios encountered during test development.

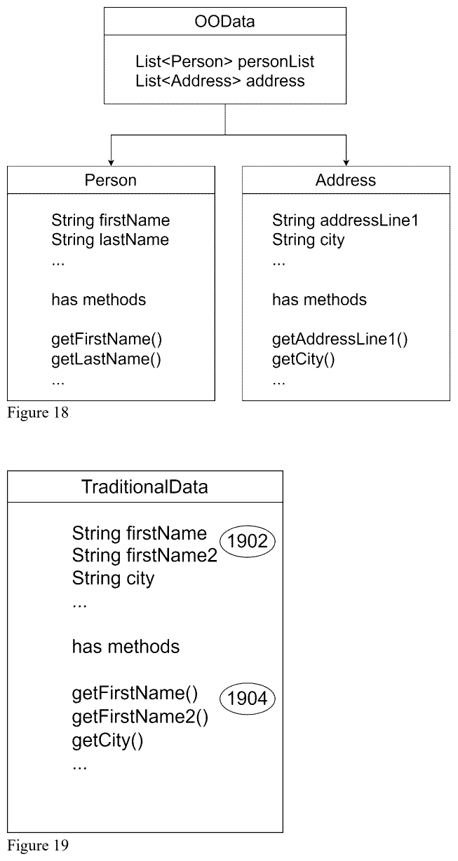

The hierarchical structure of object-oriented test data, as illustrated in FIG. 18, organizes test entities into self-contained classes encapsulated within a parent container, OOData. Unlike traditional flat structures, each reference entity, such as Person and Address, is represented as a list within OOData (e.g., personList, address), allowing for multiple instances of the same entity type. This design eliminates naming conflicts and provides context by associating data with its respective entity. For example, the Person entity contains fields such as firstName and lastName, and methods like getFirstName( ) and getLastName( ), which enable dynamic access to and manipulation of specific attributes. Similarly, Address encapsulates addressLinel and city, along with corresponding getter methods. The OOData container acts as an entry point, enabling seamless iteration over entity lists or direct access to individual entities. This hierarchical structure supports dynamic and scalable data modeling for testing, ensuring modularity and reusability across diverse test scenarios.

FIG. 19 illustrates the flattened structure typical of traditional data-driven testing approaches, encapsulated within a single class named TraditionalData. All test data fields, such as firstName, firstName2, and city, are declared as standalone variables. This structure lacks contextual grouping and hierarchical organization, making it difficult to manage as the data complexity increases. For instance, firstName and firstName2 (1902) are used to represent separate entities but rely on manual differentiation through suffixes, which is prone to naming conflicts and reduces scalability.

Each variable in TraditionalData is paired with its corresponding accessor methods, such as getFirstName and getFirstName2 (1904), which further contribute to code duplication. As the number of fields grows, the structure becomes increasingly monolithic, leading to maintenance challenges. This lack of hierarchical organization complicates data management and increases the risk of errors when scaling the test model to accommodate additional entities or attributes.

Unlike the object-oriented approach depicted in FIG. 18, the flat structure of TraditionalData demonstrates significant limitations in handling dynamic and complex test scenarios. The absence of logical grouping, such as organizing related fields into entities, results in reduced adaptability and maintainability. This approach relies heavily on manual intervention for field proliferation and naming differentiation, making it less efficient for modern testing needs.

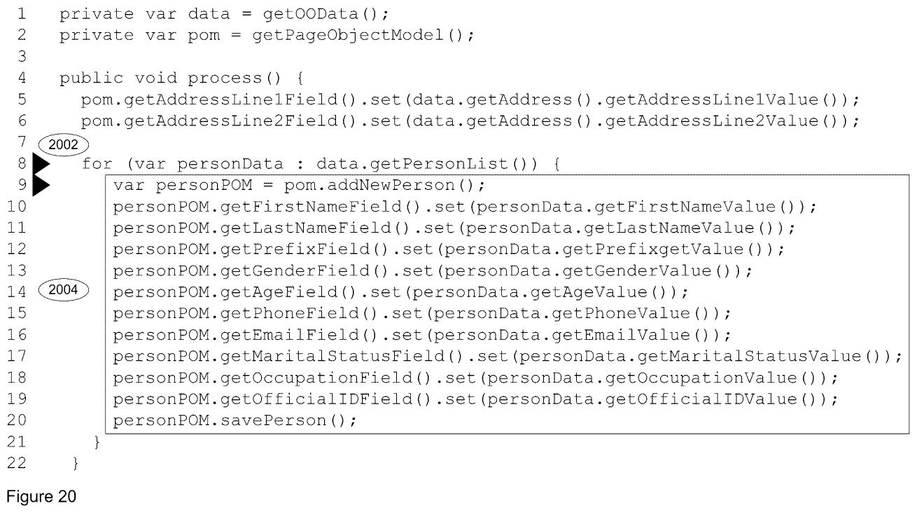

FIG. 20 illustrates the streamlined process of writing tests using object-oriented test data. In this approach, the test data loader dynamically generates a collection of entities, such as Person, which is accessed using the getPersonList method. The script iterates through the list of entities using a standard loop or iterator (2002), allowing each entity to be processed individually. For example, the loop retrieves each Person's data and sets corresponding fields in the User Interface, as shown in the iteration block (2004). This eliminates the need for predefined, uniquely named fields for multiple entities, reducing complexity and enhancing code clarity.

A key advantage of this object-oriented approach is its adaptability to varying test scenarios without additional conditional logic. The test data loader creates entries only for entities explicitly defined in the test data. For example, if a test includes one Person entity, the getPersonList method returns a collection containing a single entity. Similarly, for two entities, such as JohnSenior and LoriTeen, the collection includes both. This dynamic behavior ensures minimal changes to the test script when updating test data and provides scalability for handling an arbitrary number of entities efficiently. The approach supports modularity and maintainability, enabling reusable and adaptable test scripts for diverse scenarios.

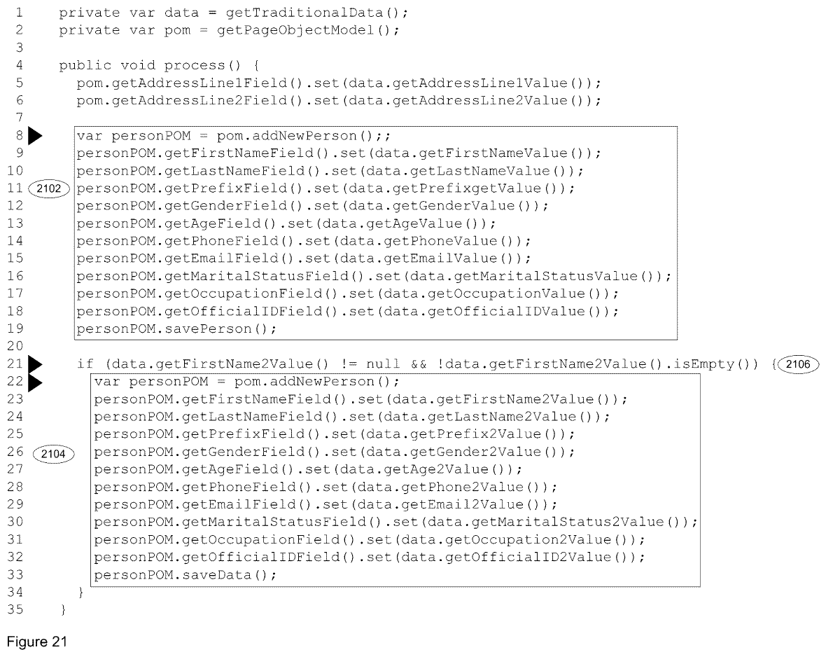

In contrast, FIG. 21 illustrates how traditional test data management relies on explicit naming and manual duplication, introducing significant inefficiencies. For example, when managing multiple instances of a Person entity, line 9 uses the property FirstName, while line 23 references FirstName 2 for the second person. This manual duplication of fields complicates the code and increases the likelihood of errors, especially when dealing with larger data sets or more complex workflows. This can be seen with two complete blocks of code: one for the first person (2102) and another for the second (2104), including logic to handle the presence or absence of the second person (line 21). Such duplication not only increases complexity and the risk of errors but also limits the scalability of tests to larger data sets. When compared to the iterative and scalable object-oriented approach depicted in FIG. 20, the traditional model clearly demonstrates its limitations in both efficiency and maintainability.

Traditional Page Object Model implementations primarily serve as structured containers for element locators and basic User Interface interactions, abstracting direct references to User Interface elements within test scripts. However, these models typically require test scripts to handle all flow logic, conditional processing, and validation mechanisms, leading to increased test script complexity and maintenance overhead.

This invention introduces a novel approach to test automation through smart widgets, which extend traditional Page Object Models by incorporating advanced capabilities such as dynamic condition handling, verification, and analytics. These widgets serve as an abstraction layer that bridges structured test data and User Interface interactions, significantly enhancing the scalability, adaptability, and maintainability of automated tests.

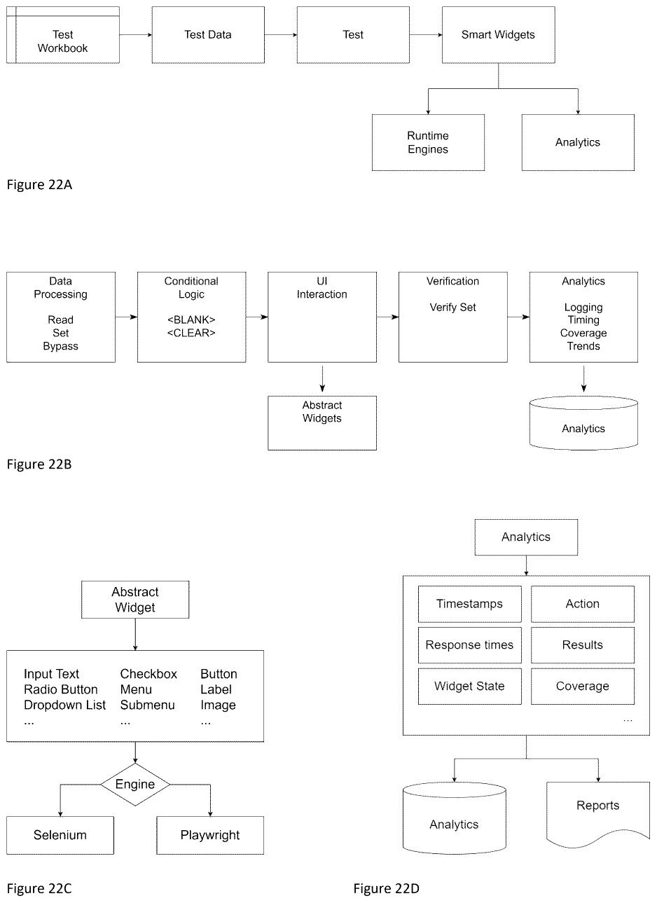

The architecture and functionality of smart widgets are described in detail through FIGS. 22A, 22B, and 22C. FIG. 22A provides an overview of the smart widget ecosystem, illustrating how test data flows through the system and interacts with widgets, runtime engines, and analytics. FIG. 22B delves into the internal processes of a smart widget, including data processing, conditional logic, and verification. FIG. 22C explains the abstract widget architecture and its integration with runtime engines, demonstrating how the system supports engine-agnostic testing workflows.

Refer to FIG. 22A for an overview of the architecture of smart widgets within the test automation framework. The process begins with the Test Workbook, which serves as the source of structured test data. The Test Data layer extracts and organizes the required information, dynamically creating object-oriented data entities. This data is passed to the Test layer, which interacts with the Smart Widgets to facilitate seamless execution of test scenarios. The Smart Widgets layer, acting as an abstraction, processes data, handles User Interface interactions, and supports runtime adaptability. It integrates with Runtime Engines, such as Selenium and Playwright, to execute browser-level operations while simultaneously recording execution details into the Analytics layer. This integration provides real-time insights into test execution, including performance metrics and coverage data, ensuring comprehensive automation with minimal manual intervention. The modular structure of this architecture enables scalability, extensibility, and maintainability across diverse test scenarios.

FIG. 22B illustrates the internal process flow within a smart widget, highlighting its layered functionality. Starting with data processing, the widget reads test data elements, determines the actions required for each field, and processes them accordingly. Fields that require no interaction are bypassed, while others are either set with the appropriate values or cleared, depending on the test requirements. The use of reserved keywords such as <BLANK> and <CLEAR> provides flexibility in test execution, ensuring explicit behavior is defined for each field.

Conditional logic within the smart widget dynamically adjusts interactions based on the context of the test data. For instance, if a field is irrelevant or disabled, it is skipped; if a value is specified as <BLANK>, it is explicitly set to empty, whereas <CLEAR> triggers an additional action to reset the field. This conditional flow ensures that the widget adapts seamlessly to varying test scenarios without requiring modifications to the test scripts.

After conditional logic, the widget performs interactions with User Interface elements, such as entering text, selecting dropdown values, or toggling checkboxes. These interactions are abstracted through the widget, allowing a single code structure to support multiple field types and behaviors.

The verification phase follows each interaction to ensure the operation was successfully executed. The widget validates that the User Interface reflects the intended state, and in cases where the action fails, retries or reports an error as necessary. By automating this verification step, the widget ensures consistency and reliability in test execution.

The abstract widget layer in FIG. 22C provides a flexible framework that accommodates various widget types, including text inputs, radio buttons, dropdown lists, checkboxes, menus, and images. This structure ensures adaptability to a wide range of User Interface elements, eliminating the need for hierarchical organization based on widget categories. The abstract widget layer abstracts interactions with the Document Object Model (DOM) and seamlessly integrates with runtime engines like Selenium and Playwright. By dynamically routing interactions to the appropriate engine at runtime, the smart widgets remain consistent and robust, regardless of variations in User Interface behavior or testing environments. This streamlined approach significantly reduces maintenance complexity while supporting diverse interaction scenarios.

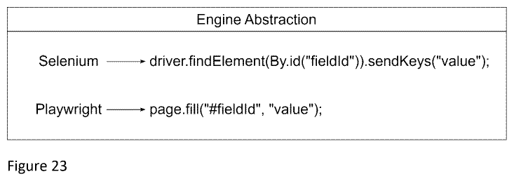

The engine layer within the architecture determines the appropriate runtime environment, such as Selenium or Playwright, based on the configuration. This abstraction ensures that test scripts remain engine-agnostic, as the widget dynamically selects and interacts with the designated runtime engine as highlighted in FIG. 23. The ability to switch between engines without modifying the widget logic provides flexibility and resilience to changes in execution environments.

At the runtime level, widgets translate abstract interactions into engine-specific commands. For example, setting a value in a text field involves different API calls in Selenium and Playwright, but this complexity is handled transparently by the widget layer. This design reduces redundancy in test scripts and ensures consistent behavior across multiple execution platforms.

By encapsulating engine-specific logic within the widget layer, the system simplifies test development and maintenance. Test scripts can focus on business logic without being burdened by the intricacies of runtime interactions. The abstract widget structure also enables easy integration of new runtime engines, ensuring long-term adaptability and scalability.

FIG. 22D illustrates the analytics layer integrated into the smart widget architecture. This layer collects detailed execution data during test automation, such as timestamps, response times, widget states, actions performed, and test coverage. The collected data is structured into actionable categories, allowing for the generation of performance insights, compliance monitoring, and test optimization. The analytics layer ensures seamless data flow from widgets to storage or reporting systems, reducing manual effort in tracking and debugging test results.

The analytics process begins by capturing detailed interactions and their outcomes within the smart widget layer. For example, timestamps record the precise moment an interaction begins and ends, while response times measure delays in application behavior. Results include whether actions, such as setting a value or interacting with a dropdown menu, succeeded. Widget states capture dynamic properties, such as whether a field is enabled, hidden, or read-only, to ensure test coverage accurately reflects application conditions.

The analytics layer also tracks test coverage to ensure that all intended elements and workflows are validated during execution. This information can identify gaps, such as untested new fields or updated application behaviors. By aligning widget interactions with corresponding test objectives, the analytics layer supports robust validation of the test scope and the application's functionality.

The data collected by the analytics layer is processed for consumption in two primary forms: storage and reporting. Data can be stored in a dedicated analytics database for long-term retention and trend analysis, allowing testers to monitor performance over time or across multiple test runs. Reporting systems transform raw data into human-readable formats, such as charts or summary reports, providing actionable insights into test execution performance, errors encountered, and areas for improvement.

The inclusion of the analytics layer provides several benefits. It eliminates the need for testers to manually instrument tests with additional logging, ensures test execution details are captured consistently, and allows for real-time monitoring of application behavior during test runs. This functionality aligns with the goals of reducing test script complexity, improving system reliability, and delivering comprehensive insights for stakeholders without additional coding effort.

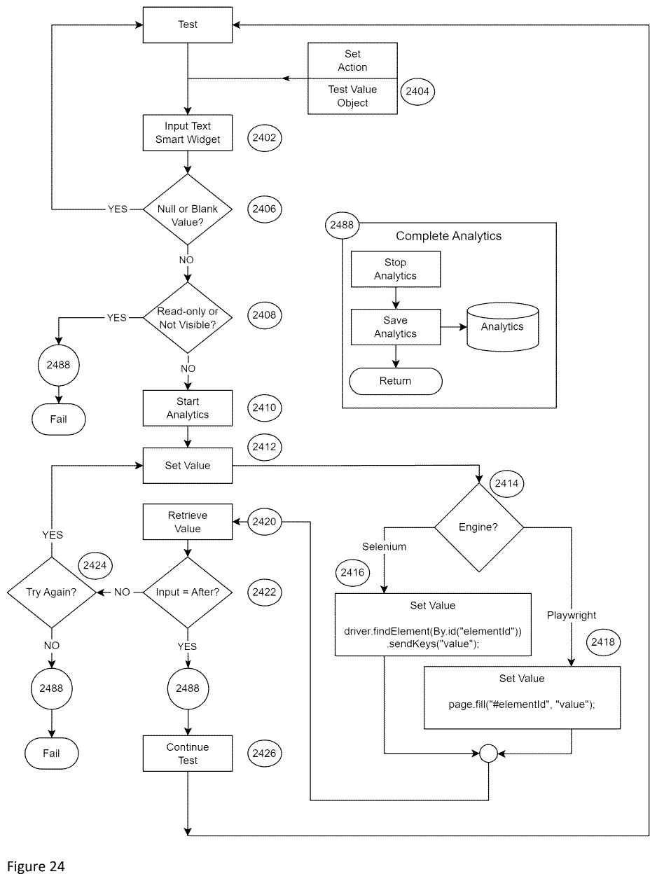

FIG. 24 is a flowchart of a test interacting with a widget, from the initial call to the widget to the completion of the action and the return to the test. The flow represents a generalized process applicable to all widget types, although variations may exist based on the widget's specific functionality. For example, input widgets may include verification and retry processing, while label widgets may focus solely on value retrieval.

The process begins with the test invoking a purpose-specific widget (2402), an Input Text widget in this case, for the element being set by invoking the action and passing the necessary test data property (2404). The widget determines its corresponding physical User Interface element onscreen using its internal mapping, eliminating the need for external element identification logic.

The widget begins processing by first checking whether the value provided is null or blank (2406). If the value is null or blank, the widget bypasses the interaction for this field and logs the event. This allows the test to continue to the next action or field while preventing unnecessary interactions and maintaining comprehensive analytics.

If the value is not null or blank, the widget checks whether the field is read-only or not visible (2408) to the user. Although the DOM may permit interaction with fields that are inaccessible to users, such interactions are generally invalid in real-world scenarios. If the field is determined to be read-only or not visible, the widget invokes the complete analytics subroutine (2288), halts the action, and notifies the test script.

If the field passes the availability check, the widget starts analytics tracking (2410). This involves logging interaction metadata, such as the field identifier, the action being performed, the value being set, and the timestamp for the start of the interaction.

At this point, the invention is ready to interact with the physical widget (2412). It determines which runtime engine (e.g., Selenium or Playwright) to use (2414) and dynamically invokes either Selenium's sendKeys method (2416) or Playwright's fill method (2418) to set the field's value.

Once the value is set, the widget verifies the operation by retrieving the field's current value (2420) and comparing it against the expected result (2422). This verification process accounts for discrepancies caused by application behavior. For example, in Canada, mailing addresses require two spaces between the province and postal code, but some browsers automatically compress this to a single space. Without accounting for such discrepancies and adjusting the verification process accordingly, you would get negative failures when the relevant data actually matches.

If the retrieved value does not match the expected result, the system evaluates whether further attempts should be made (2424). This decision depends on the test configuration, which may allow retries under specific conditions or fail immediately if retries are deemed unnecessary. If retries are unsuccessful or the value still fails to match after the allowed attempts, the widget invokes the complete analytics subroutine (2488), the failure is logged, and control returns to the test script.

If the verification succeeds or retries are successful, the widget completes analytics (2488) and returns control to the test script (2426) to process additional widgets as needed.

By incorporating retry mechanisms, robust verification steps, and abstracted engine layers, intelligent widgets enhance reliability and resilience during test execution while simplifying writing the test. The integration of analytics tracking ensures precise monitoring of interactions, eliminating the need for the test to implement this functionality itself, thereby enabling effective debugging and compliance analysis.

FIG. 24 is a flowchart of a test interacting with a widget, from the initial call to the widget to the completion of the action and the continuation of the test. The flow represents a generalized process applicable to all widget types, although variations may exist based on the widget's specific functionality. For example, input widgets may include verification and retry processing, while label widgets may focus solely on value retrieval.

The process begins with the test invoking a purpose-specific widget (2402), such as an Input Text widget, for the element being set by invoking the action and passing the necessary test data property (2404). The widget determines its corresponding physical User Interface element onscreen using its internal mapping, eliminating the need for external element identification logic.

The widget begins processing by first checking whether the value provided is null or blank (2406). If the value is null or blank, the widget bypasses the interaction for this field and logs the event. This allows the test to continue to the next action or field while preventing unnecessary interactions and maintaining comprehensive analytics.

If the value is not null or blank, the widget checks whether the field is read-only or not visible (2408) to the user. Although the DOM may permit interaction with fields that are inaccessible to users, such interactions are generally invalid in real-world scenarios. If the field is determined to be read-only or not visible, the widget invokes the complete analytics subroutine (2488), halts the action, logs the failure, and returns a status to the test script indicating the failed interaction. The test script may then determine whether to handle the failure or terminate execution.

If the field passes the availability check, the widget starts analytics tracking (2410). This involves logging interaction metadata, such as the field identifier, the action being performed, the value being set, and the timestamp for the start of the interaction. The analytics data is stored in a structured format for future consumption, such as debugging, optimization, or compliance monitoring.

At this point, the invention interacts with the physical widget (2412). It determines which runtime engine (e.g., Selenium or Playwright) to use (2414) and dynamically invokes either Selenium's sendKeys method (2416) or Playwright's fill method (2418) to set the field's value.

Once the value is set, the widget verifies the operation by retrieving the field's current value (2420) and comparing it against the expected result (2422). This verification process accounts for discrepancies caused by application behavior. For example, in Canada, mailing addresses require two spaces between the province and postal code, but some browsers automatically compress this to a single space. Such discrepancies are handled through configurable logic within the widget, allowing testers to define rules for acceptable variations.

If the retrieved value does not match the expected result, the system evaluates whether further attempts should be made (2424). This decision depends on the test configuration, which may allow retries under specific conditions or fail immediately if retries are deemed unnecessary. For instance, retries are often used to address issues like transient network latency or asynchronous rendering of elements. If retries are unsuccessful or the value still fails to match after the allowed attempts, the widget invokes the complete analytics subroutine (2488), logs the failure, and returns a status to the test script indicating the failed interaction.

If the verification succeeds or retries are successful, the widget completes analytics (2488) and returns control to the test script (2426). In this scenario, no status is explicitly returned, and the test continues as though the action was performed without interruption.

By incorporating retry mechanisms, robust verification steps, and abstracted engine layers, intelligent widgets enhance reliability and resilience during test execution while simplifying writing the test. The integration of analytics tracking ensures precise monitoring of interactions, eliminating the need for the test to implement this functionality itself, thereby enabling effective debugging and compliance analysis.

To conclude, this section consolidates and summarizes the previously described elements, bringing together the concepts of reference worksheets, test worksheets, and their associated code implementations. This provides a comprehensive view of how the invention integrates these components into a cohesive framework for efficient and scalable test automation.

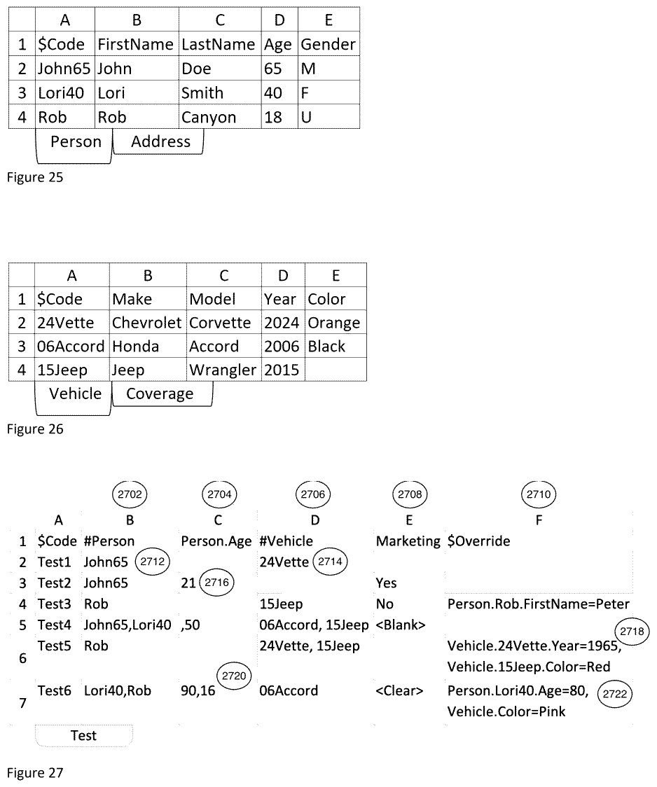

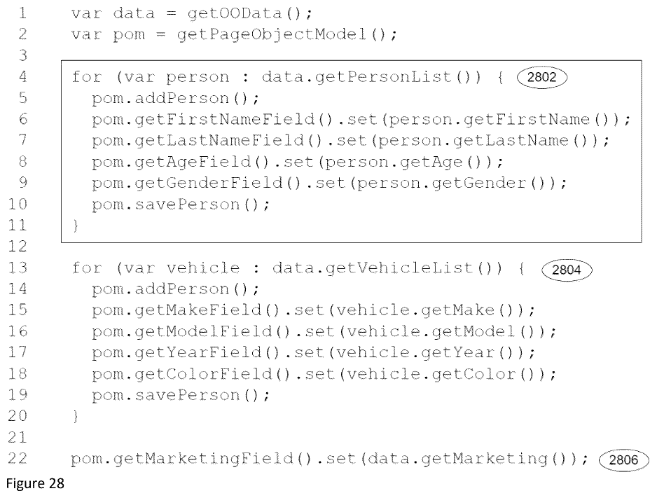

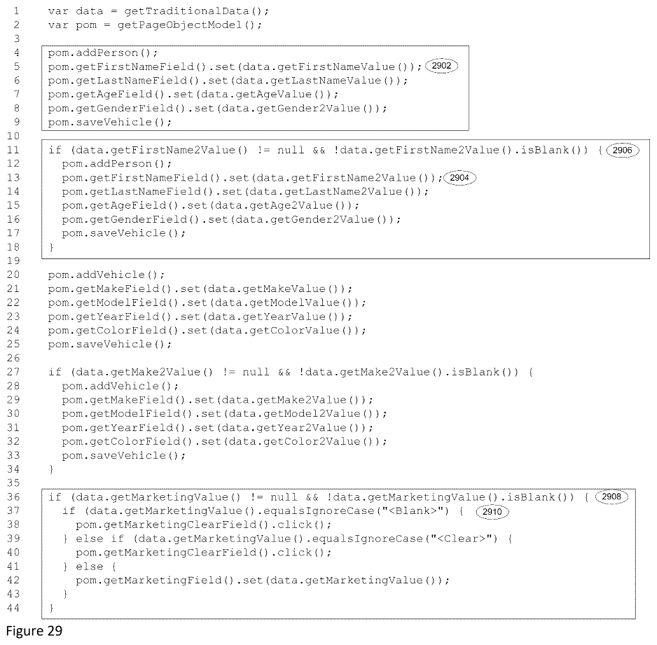

The invention integrates two reference worksheets. The Person worksheet, as depicted in FIG. 25, organizes attributes for individual persons, such as FirstName, LastName, Age, and Gender, while the Vehicle worksheet, shown in FIG. 26, structures vehicle attributes, including Make, Model, Year, and Color. These reference worksheets provide reusable, structured definitions for entities used in the test worksheet, ensuring consistency across multiple test cases. The test worksheet, illustrated in FIG. 27, dynamically links test cases to these reference entities using the #Person (2702) and #Vehicle (2706) columns, eliminating data duplication and ensuring consistency. Additionally, the test worksheet includes runtime override columns Person. Age (2704) and $Override (2710), and custom field Marketing (2708), extending flexibility and adaptability. Object-oriented and traditional test data code examples are presented in FIGS. 28 and 29, highlighting the contrasting efficiencies between these approaches.

FIG. 27 demonstrates the dynamic referencing capability of the test worksheet. Using reference columns #Person and #Vehicle, test cases can directly associate with corresponding entities from the Person and Vehicle worksheets by referencing their $Codes. For instance, Test1 links John65 (2712) from Person and 24Vette (2714) from Vehicle, enabling dynamic, reusable relationships. This reduces redundant data duplication and streamlines test management, ensuring accuracy and consistency across various scenarios. The test worksheet also facilitates runtime customizations and overrides for entity attributes, such as modifying Rob's age or updating the Corvette's year, without altering the original reference data.

The override columns in the test worksheet, such as Person. Age and $Override, enable dynamic customization during test execution. For example, Rob's age can be changed to 21 (2716), or the Corvette's year can be updated to 1965 (2718), reflecting these changes during the test without modifying the underlying reference worksheets. The $Override column can also override an already overridden column, such as overriding Lori40's age to 80 using $Override (2722) even after a column override (2720) set it to 90.

Custom fields like the Marketing (2708) column in the test worksheet offer extensibility to meet specific business or testing requirements. For example, the Marketing column allows for additional test data elements, such as campaign-specific configurations, without altering the core structure of the worksheets. This flexibility supports evolving test needs and allows testers to implement business-specific scenarios efficiently.

FIG. 28 demonstrates the object-oriented approach to test data processing. Dynamic iterators, such as getPersonList (2802) and getVehicleList (2804), retrieve and process entities referenced in the test worksheet. Smart widgets manage all interactions, including specialized fields like Marketing (2806), abstracting complexities and reducing maintenance efforts. This approach ensures test scripts remain clean, reusable, and adaptable to changes in data or workflow.

Conversely, FIG. 29 highlights the limitations of traditional data-driven testing. Flattened data structures result in duplicated columns and hardcoded logic for fields, such as getFirstName Value and getFirstName2Value (2902, 2904). This approach requires manual logic to verify and process test data (2906), leading to increased complexity and error risk. Specialized keywords like <Blank> and <Clear> also require explicit handling (2908, 2910), adding to the maintenance burden. Unlike the object-oriented approach, the traditional method lacks scalability and efficiency, making it unsuitable for complex test scenarios.

This invention provides a scalable and robust framework for managing complex test data scenarios. By integrating object-oriented test data, test worksheets, and smart widgets, it minimizes redundancy, enhances test execution efficiency, and reduces maintenance overhead. Leveraging spreadsheets such as Excel to manage object-oriented entities offers a familiar and accessible platform for business users, testers, and developers, while maintaining the advantages of object-oriented principles.

1. A computer-implemented method for executing automated tests using object-oriented data structures, the invention comprising storing test data as object-oriented entities encapsulating related attributes within a data storage medium serving as passive data storage containing no formulas or calculations, wherein said entities emulate real-world objects to improve test data readability and maintainability, organizing said entities as reference entities containing structured attribute sets, associating said object-oriented entities with test cases in a test dataset using reference identifiers that dynamically link test data to said reference entities, wherein said test dataset supports specialized data-driven directives embedded within data values to influence test execution behavior. applying data overrides to modify specific attributes of said object-oriented entities for a given test scenario without altering the underlying reference data, incorporating test-specific data that is not contained within said reference entities, constructing a hierarchical test data structure by resolving references from said test dataset to said reference entities while maintaining logical relationships between entities, and executing an automated test using said hierarchical test data structure to enable dynamic retrieval and processing of entity attributes during test execution, wherein all semantic processing of references, overrides, and directives occurs within an external automation framework rather than within the data storage medium.

2. The system and method of claim 1, wherein the hierarchical test data structure supports multiple object-oriented entities of the same type within a single test case.

3. The system and method of claim 1, wherein reference entities are stored in a structured format for reuse across multiple test cases.

4. The system and method of claim 1, wherein data overrides modify object-oriented entity attributes dynamically at runtime.

5. The system and method of claim 1, wherein test-specific data is incorporated into the hierarchical test data structure as a separate data layer.

6. The system and method of claim 1, wherein the hierarchical test data structure is transformed into programmatically accessible data objects with generated accessors.

7. The system and method of claim 1, wherein test execution adapts to missing or incomplete data by bypassing unavailable attributes, applying default values, or skipping non-essential steps.

8. The system and method of claim 1, wherein specialized data-driven directives are embedded within the test dataset to influence test execution behavior.

9. A computer-implemented method for executing automated tests using object-oriented data structures within a spreadsheet-based environment, the invention comprising structuring test data as object-oriented entities encapsulating related attributes, storing said entities within a spreadsheet comprising one or more reference worksheets, serving as passive data storage containing no formulas or calculations. associating said object-oriented entities with test cases in a test worksheet using reference identifiers that dynamically link test data to said reference worksheets, wherein said test worksheet supports specialized data-driven directives embedded within cell values to influence test execution behavior. applying data overrides and test-specific modifications directly within the spreadsheet to modify entity attributes for a given test scenario without altering the original reference data, constructing a hierarchical test data structure by resolving references from the test worksheet to said reference worksheets while maintaining logical relationships between entities, wherein all semantic processing of references, overrides, and directives occurs within an external automation framework rather than within the spreadsheet application, and executing an automated test using said hierarchical test data structure, wherein said spreadsheet-based approach enables business users, testers, and developers to collaboratively create, maintain, and utilize test data without requiring specialized database or programming expertise.

10. The invention of claim 9, wherein reference worksheets store object-oriented entities in a structured tabular format.

11. The invention of claim 9, wherein the test worksheet utilizes reference columns to dynamically link test cases to reference worksheets using one or more reference identifiers.

12. The invention of claim 9, wherein data overrides are applied within the spreadsheet to modify entity attributes at the test case level without altering the reference worksheet.

13. The invention of claim 9, wherein the spreadsheet format supports specialized directives, including keywords such as <Blank> and <Clear> to modify test data values or test flow.

14. The invention of claim 9, wherein the spreadsheet-based hierarchical test data structure is dynamically loaded into an automation framework as object-oriented runtime objects.

15. The invention of claim 9, wherein business users, testers, and developers collaborate within the same spreadsheet environment to define, modify, and execute tests.

16. A computer-implemented method for executing automated tests using smart widgets, the invention comprising providing reusable, data-driven interface components that dynamically interact with application elements based on test data, receiving structured or unstructured test data defining input values and expected outcomes, wherein said test data comprises either simple data values or object-oriented entity structures originating from passive data storage containing no formulas or calculations, and includes specialized directives that enable business users or testers to influence test execution behavior, executing test interactions wherein said smart widgets determine the appropriate element, interaction type, and verification method based on predefined logic, selectively bypassing interactions or applying conditional processing based on test data conditions, wherein all semantic processing of references, overrides. and directives occurs within an external automation framework rather than within said smart widgets or any underlying data storage application, capturing execution analytics to track widget performance, test coverage, and User Interface responsiveness, abstracting User Interface interactions from underlying automation frameworks to enable execution across multiple runtime environments, and allowing modifications to said smart widgets to support application changes without requiring updates to test scripts, thereby improving test maintainability, scalability, and resilience to User Interface modifications.

17. The invention of claim 16, wherein said smart widgets selectively bypass interactions for fields or elements that are missing, disabled, or not applicable based on test data conditions.

18. The invention of claim 16, wherein said smart widgets support conditional processing by executing predefined logic based on test data values.

19. The invention of claim 16, wherein said smart widgets incorporate embedded analytics that track and record test execution details, including interaction success rates, timing metrics, and element state validation.

20. The invention of claim 16, wherein said smart widgets abstract User Interface interactions from specific automation frameworks, enabling test execution across different runtime environments, including Selenium and Playwright.

21. The invention of claim 16, wherein said smart widgets enable business users or testers to influence test execution behavior through test data directives, including specialized values such as <Blank> and <Clear>.

22. The invention of claim 16, wherein modifications to said smart widgets allow automated tests to remain functional despite application changes.

23. The invention of claim 16, wherein said smart widgets verify interactions by retrieving post-interaction element states and applying predefined comparison logic.

24. The invention of claim 1, wherein applying data overrides further comprises logging each override operation to an override history that preserves the sequence in which overrides were applied, the original value before override, the new value after override, and the source mechanism of the override, thereby enabling programmatic reconstruction of test entity state at each processing layer for audit, debugging, and analysis purposes.
